(19) United States
(12) Patent Application Publication
(10) Pub. No.: US 2026/0307844 A1
(43) Pub. Date: Oct. 8, 2026

(54) TECHNIQUE FOR HANDLING A LABEL TAPE FROM A LABEL ROLL

(71) Applicant: KRONES AG, Neutraubling (DE)

(72) Inventors: Michael NEUBAUER, Grassau (DE); Benjamin GROSSMAN, Regensburg (DE); Dejan ANTIC, Regensburg (DE); Viktor GETTE, Woerth an der Donau (DE); Martin WAGNER, Regensburg (DE)

(21) Appl. No.: 19/424,462

(22) Filed: Dec. 18, 2025

(30) Foreign Application Priority Data
Jan. 31, 2025 (DE) 10 2025 103 645.4

(51) Int. Cl. B65C 9/18; B65H 19/18; B65H 19/26

(52) U.S. Cl. CPC B65C 9/18; B65H 19/1852; B65H 19/26; B65H 2301/46115; B65H 2406/34; B65H 2801/75

(57) ABSTRACT

The invention relates, to an apparatus for a label tape gripping apparatus, for handling a label tape. The apparatus has a shaft for rolling up a portion of the label tape from a label roll for holding the label tape on the shaft and a base body that is arranged next to the shaft for applying a portion of the label tape adjacent to the rolled-up portion of the label tape.

### TECHNICAL FIELD

The invention relates to an apparatus for handling a label tape, a robot, a labeling system, and an associated operating method.

### TECHNICAL BACKGROUND

A container treatment plant can comprise a labeling device for labeling containers. For example, the labeling device can label the containers with labels from a label roll (roll of label material).

Traditionally, the label rolls are refilled manually by an operator. The user may have to perform additional tasks, such as cutting the label tape to the correct position, applying double-sided adhesive tape to the label tape, or inserting the label tape into an automatic bonding unit. It is also possible to use roll magazines, which can be manually loaded with a plurality of rolls.

DE 10 2021 125 133 A1 describes a mobile robot, a supply system, and a method for changing label rolls on a labeling unit for labeling containers. The mobile robot accordingly comprises a vehicle unit for changing locations of the robot and a manipulator unit with a multi-axis manipulator and an associated end effector for manipulating label rolls. Since the end effector is formed to grip the outer circumference of the label rolls and emptied roll cores of label rolls so as to carry them, ergonomically problematic work steps when refilling label rolls can be accomplished exclusively by machine with a high degree of precision and in a material-saving manner.

EP 3 760 550 A1 describes a transfer unit for feeding rolls of labeling material to a labeling module that is configured to apply labels to objects. The transfer unit includes a support element configured to support a plurality of rolls arranged vertically in at least one stack. The transfer unit further has a robot arm configured such that it removes at least one roll from the stack at a gripping station and releases it at a release station.

The invention is based upon the object of creating an improved technique for handling label tapes for loading a labeling apparatus.

### SUMMARY OF THE INVENTION

The object is achieved by the features of the independent claims. Advantageous developments are specified in the dependent claims and the description.

One aspect relates to an apparatus, preferably an (e.g., label tape) gripping apparatus, for handling a label tape. The apparatus has a shaft for rolling up (winding) a portion of the label tape from a label roll to hold the label tape on the shaft. The apparatus further has a base body that is arranged next to the shaft for applying a portion of the label tape adjacent to the rolled-up portion of the label tape.

In this way, a compact and universally usable robot gripper for label tape handling can advantageously be provided. Since the label tape can be securely fixed using the shaft and can, for example, be cut only at the very end of the handling process, a high degree of process reliability is advantageously achieved. By controlling the tape force via the shaft, a taut yet gentle transport of the label tape can advantageously be enabled. The apparatus can advantageously be used in combination with an adhesive tape dispenser to prepare the label tape for a variety of roll receptacles (e.g., applying adhesive strips in the correct position, cutting it to size in the correct position). The apparatus can also be advantageously used to secure a partially used roll of labels, e.g., in combination with an adhesive tape dispenser. In combination with a roll gripper, the apparatus can advantageously provide a fully automated solution for the supply of consumables.

In one exemplary embodiment, at least one of the following conditions is met:
the shaft is a hollow shaft;
an outer circumferential face of the shaft has a non-stick coating;
the shaft has a longitudinal gap, preferably a longitudinal suction gap and/or longitudinal clamping gap, for receiving the leading end of the portion of the label tape;
the shaft is rotatably mounted at only one end side of the shaft;
the shaft has a circumferential shoulder (e.g., a collar or band) at its free end, preferably in certain portions or completely, to prevent the label tape from slipping off the shaft;
the shaft has a total shaft length ≥200 mm and/or ≤300 mm; and
the shaft has an outer diameter ≥50 mm and/or ≤100 mm.

In a further exemplary embodiment, the apparatus also has a suction device for drawing the label tape to and/or into the shaft and/or a clamping device for clamping the label tape in and/or on the shaft.

In one embodiment, at least one of the following conditions is met:
the suction device is arranged in the shaft;
the suction device is connected to the shaft in a rotationally fixed manner;
the suction device has a suction nozzle for sucking in the leading end of the label tape portion into the suction nozzle, wherein the suction nozzle opens in an outer circumferential face of the shaft, preferably in a longitudinal gap of the shaft and/or substantially along the entire length of the shaft; and
the suction device has a vacuum line that is arranged in the shaft, e.g., parallel to and at a distance from a central longitudinal axis of the shaft.

In a further embodiment, at least one of the following conditions is met:
the clamping device is arranged in the shaft;
the clamping device is pneumatically actuated, preferably using a pneumatic clamping actuator in the shaft;
the clamping device has two clamping elements (e.g., clamping plates) that are movable relative to one another and are preferably aligned with a longitudinal gap of the shaft;
the clamping device is connected to the shaft in a rotationally fixed manner;
the clamping device is arranged to clamp a leading end, sucked into the shaft, of a portion of the label tape; and
the clamping device extends substantially along an entire length of the shaft.

In one embodiment variant, the apparatus also has a tape sensor that is arranged to detect a label tape held by the shaft.

In a further embodiment variant, at least one of the following conditions is met:
the tape sensor is arranged in the shaft, preferably to detect the portion projecting into the shaft through a longitudinal gap in the shaft;
the tape sensor is an optical sensor, preferably a laser sensor or an LED sensor;
the tape sensor is connected to the shaft in a rotationally fixed manner; and
the tape sensor is arranged in or on a free end region of the shaft.

In one exemplary embodiment, the apparatus further has a drive unit (e.g., servomotor), preferably electric, which is connected in a driving manner to the shaft to rotate the shaft. Preferably, at least one of the following conditions can be met:
the drive unit is connected to the shaft via a transmission connection, preferably having a planetary gearbox, an angular gearbox, a cycloidal gearbox, and/or a belt drive, or is directly connected to the shaft;
the drive unit is connected to the shaft via a compensating coupling, preferably an axis misalignment and/or angular misalignment compensating coupling, particularly preferably a bellows coupling; and
the drive unit is configured, when the entire apparatus is moved, to drive the shaft in a force-controlled manner, depending upon a load (e.g., detected by a sensor) on the shaft and/or the apparatus, in order to apply a tape force to the label tape, preferably for preventing sagging and/or damage to the label tape.

Preferably, the load can be detected by sensors, e.g., as force or torque on the shaft or another part of the apparatus, or as a motor current of the drive unit.

It is also possible that a drive unit, which is connected in a driving manner to a label roll receptacle (e.g., a film plate) on which the label roll can be received, is configured to drive the label roll receptacle (e.g., its shaft) in a force-controlled manner, depending upon a load (e.g., sensor-detected) on the label roll receptacle, preferably for preventing sagging and/or damage to the label tape.

In a further exemplary embodiment, the base body has at least one of the following:
at least one cutting device, preferably pneumatically actuated, for cutting off the portion of the label tape resting against the base body;
at least one suction device for holding the portion of the label tape resting against the base body;
at least one reflector, preferably a reflector tape, for print mark recognition on a transparent label tape;
at least one heating device for heating the portion of the label tape resting against the base body (e.g., for improving the adhesive effect of an adhesive);
at least one, preferably friction-reducing, deflecting element, preferably a guide roller or a sliding element, on at least one edge region of the base body for guiding the label tape around the particular edge region; and
at least one elastically mounted, preferably spring-loaded, transfer bar for supporting the transfer of the label tape resting against the base body.

In one embodiment, at least one of the following conditions is met:
the base body has a recess, preferably substantially cylindrical segment-shaped, into which the shaft partially immerses;
the base body has a circumferential shoulder (e.g., a collar or ridge; e.g., in a plane with the shoulder of the shaft) at its free end, preferably in certain portions or completely, for preventing the label tape from slipping off the base body;
the base body has a substantially triangular or substantially quadrilateral cross-section, preferably along its entire length; and
the base body has a total length that substantially corresponds to the total length of the shaft.

In a further embodiment, at least one of the following conditions is met:
the apparatus is an end effector for a robot, preferably a multi-axis robot, particularly preferably an articulated-arm robot;
the apparatus has a support flange for attaching the apparatus to a robot arm of a robot, wherein preferably a central axis of the support flange is offset, preferably parallel offset, to a central axis of the shaft; and
the apparatus has a connection interface, preferably pneumatic and/or electrical, for connecting a robot drag chain having at least one supply line.

A further aspect relates to a robot, preferably a multi-axis robot, particularly preferably an articulated-arm robot. The robot has an apparatus as disclosed herein and an adhesive tape dispenser (preferably attached to a base or a movable axis (e.g., main axis of rotation) of the robot) for dispensing adhesive tape onto a portion, resting against the contact face of the base body of the apparatus, of the label tape. Advantageously, the robot can achieve the same advantages as already described with reference to the apparatus.

A further aspect relates to a labeling system for labeling containers. The labeling system has two label roll receptacles for receiving one label roll each, a bonding device (e.g., a splicing device) for joining a leading end of a label tape from one of the label rolls to an end of a label tape of the other label roll, and a robot as disclosed herein. The robot is configured (e.g., using a processing device) to feed a portion of a label tape from a label roll selectively from one of the two label roll receptacles to the bonding device and, optionally, to prepare the portion for the bonding device, preferably by cutting it to size and/or providing it with an adhesive (e.g., double-sided adhesive tape). Advantageously, the labeling system can achieve the same advantages as already described with reference to the apparatus.

In one exemplary embodiment, the labeling system further has a (e.g., stationary) receiving device for receiving tape remnants. The receiving device has a suction unit for drawing in and sucking in a tape remnant from the shaft, a clamping unit for clamping a tape remnant that has been drawn in, and a collection container for collecting tape remnants that have been sucked in. Advantageously, this can also make the automated removal of tape remnants possible.

It is explicitly pointed out that the receiving device is herein disclosed and can be claimed as an independent aspect.

For example, the receiving device can be arranged next to the robot.

Preferably, the robot (e.g., using a processing device) is configured to move the shaft with a tape remnant held to it to the receiving device for removal of the tape remnant. Preferably, the robot can also be configured (e.g., using a processing device) to rotate the shaft for unwinding the tape remnant and/or to move the shaft away from the clamping unit, e.g., if the tape remnant has been drawn in by the suction unit and clamped by the clamping unit.

A further aspect relates to a container treatment plant (e.g., for controlling temperature, producing, cleaning, coating, testing, filling, closing, pasteurizing, decorating, labeling, printing, marking, laser marking, and/or packaging containers for liquid or pasty media, preferably beverages, liquid foods, or products from the pharmaceutical or healthcare industry). The container treatment plant can have the apparatus as disclosed herein, the robot as disclosed herein, or the labeling system as disclosed herein. The container treatment plant can, for example, be a beverage filling plant.

For example, the containers can be realized as bottles, cans, canisters, cartons, vials, tubes, etc.

A further aspect relates to a method for operating an apparatus as disclosed herein, or a robot as disclosed herein, or a labeling system as disclosed herein. The method involves the following:
rolling up (winding) a portion of a label tape from a label roll, which is preferably received in a label roll receptacle of a labeling system, onto the shaft for holding the label tape to the shaft; and
applying a portion of the label tape adjacent to the rolled-up portion of the label tape to the base body by moving, preferably rotating, the entire apparatus, preferably using a robot.

Advantageously, the method can achieve the same advantages as already described with reference to the apparatus.

In one exemplary embodiment, the method further involves at least one of the following:
receiving the leading end of the portion of the label tape in a longitudinal gap of the shaft before rolling up;
drawing in the leading end of the portion of the label tape onto or into the shaft using a suction device of the apparatus;
clamping the leading end of a portion of the label tape to or in the shaft using a clamping device of the apparatus;
holding the portion, adjacent to the rolled-up portion of the label tape and resting against the base body, of the label tape against the base body by drawing in using a suction device of the apparatus;
moving the apparatus with the rolled-up portion of the label tape, preferably using a robot arm, to a treatment device for treating the label tape, preferably for recognizing a cut mark of the label tape and/or for applying an adhesive strip;
heating the portion, adjacent to the rolled-up portion of the label tape and resting against the base body, of the label tape by a heating device of the apparatus;
moving the apparatus with the rolled-up portion of the label tape, preferably using a robot arm, to a bonding device of a labeling system for bonding the label tape to one end of another label tape;
adapting, preferably controlling, a tape force acting upon the label tape (e.g., depending upon a sensor-detected load on the shaft and/or the apparatus) using a drive unit connected to the shaft and/or using a drive unit connected to the label roll receptacle, when moving the apparatus (e.g., using a robot arm), preferably for preventing sagging and/or damage (e.g., excessive stretching) to the label tape; and
cutting the label tape using a cutting device of the apparatus, preferably at a bonding device of a labeling system for bonding the label tape to one end of a further label tape.

In a further exemplary embodiment, the method also involves: removing a tape remnant at the shaft, involving:
drawing in the tape remnant from the shaft using a suction unit of a (e.g., stationary) receiving device (e.g., arranged adjacent to the robot);
clamping the tape remnant that has been drawn in, using a clamping unit of the receiving device;
removing the clamped tape remnant from the shaft by moving the shaft away from the clamping unit (e.g., using the robot) and/or unwinding the tape remnant from the shaft by rotating the shaft; and, optionally,
sucking in the tape remnant removed from the shaft into a collection container of the receiving device, using the suction unit; and preferably
releasing the clamped tape remnant using the clamping unit during the sucking in.

It is possible that the drawing-in is deactivated during clamping and removal, e.g., for saving energy.

The preferred embodiments and features of the invention described above can be combined with one another as desired.

### BRIEF DESCRIPTION OF THE FIGURES

Further details and advantages of the invention are described below with reference to the accompanying drawings. In the figures:

FIG. 1 is a schematic perspectival view of a label roll;

FIG. 2 is a perspectival view of an apparatus according to an exemplary embodiment;

FIG. 3 is a side view of the exemplary apparatus;

FIG. 4 is a perspectival sectional view of a shaft and a base body of the exemplary apparatus with a partial interior view;

FIG. 5 is a top view of the sectional view of the shaft and the base body of FIG. 4;

FIG. 6 is a perspectival side view of the shaft and the base body of the exemplary apparatus with a partial interior view;

FIG. 7 is a perspectival view of a cutting device of the exemplary apparatus;

FIGS. 8 to 10 are top views of the cutting device of FIG. 7 in different positions;

FIG. 11 is a bottom view of the shaft and the base body of the exemplary apparatus;

FIG. 12 is a perspectival view of a robot according to an exemplary embodiment;

FIG. 13 is a perspectival view of a robot according to a further exemplary embodiment;

FIG. 14 is a perspectival view of a modified portion of the exemplary apparatus;

FIGS. 15 to 22 are schematic representations of exemplary apparatuses according to different exemplary embodiments;

FIG. 23 is a perspectival view of a portion of a labeling system according to an exemplary embodiment;

FIGS. 24 to 67 show exemplary method steps of a method for handling a label tape;

FIG. 68 is a perspectival view of a portion of a labeling system according to an exemplary embodiment;

FIG. 69 is a perspectival view of a portion of a labeling system according to one exemplary embodiment;

FIG. 70 is a perspectival view of a portion of a labeling system according to one exemplary embodiment;

FIG. 71 is a perspectival view of a portion of a receiving device for receiving tape remnants; and

FIG. 72 is a sectional view through a portion of the receiving device of FIG. 71.

The embodiments shown in the figures correspond at least in part, so that similar or identical parts are provided with the same reference signs, and reference is also made to the description of other embodiments or figures for the explanation thereof to avoid repetition.

### DETAILED DESCRIPTION OF EXEMPLARY EMBODIMENTS

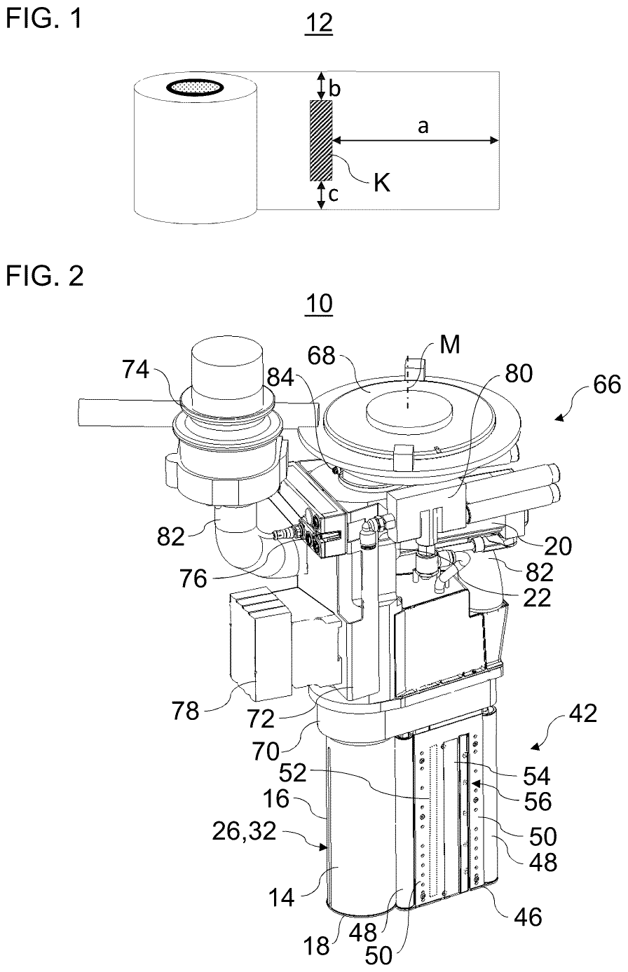

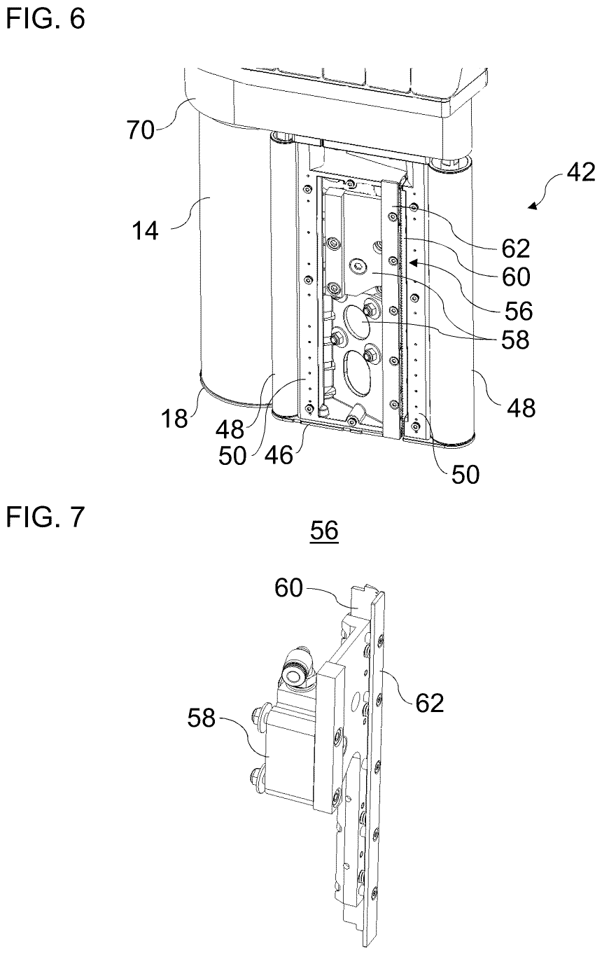

FIGS. 2 to 10 are different views and portions of an apparatus 10 for handling a label tape from a label roll 12, as shown by way of example in FIG. 1.

Label tapes or their label rolls 12 that can be handled with the apparatus 10 can, for example, have a height in a range between 20 mm and 200 mm, wherein other tape heights are likewise conceivable. The label tape material can preferably be polypropylene (PP), although other tape materials are also conceivable.

Using the apparatus 10, a label tape can be picked up (grasped) and the label tape thus picked up can be handled and, for example, treated. Thus, the apparatus 10 can also be described as a label tape gripping apparatus (tool for gripping a label tape) for handling a label tape.

Preferably, the apparatus 10 can be configured as an end effector for attachment to a robot arm of a robot, preferably a multi-axis robot, e.g., an articulated-arm robot. For example, it is possible for the robot to take up the apparatus 10 at a tool changing station, preferably automatically. For example, the robot could change the apparatus 10 and a label roll gripper for gripping and handling entire label rolls 12 at the tool change station as needed. It is possible that the apparatus 10 will be used in other applications.

The apparatus 10 can preferably fulfill different functions and perform different activities, as briefly introduced below, but also still explained in detail herein.

For example, the apparatus 10 can recognize, receive, and fix the leading end of the tape of a label roll 12. As a further example, the apparatus 10 can wind up a leading end of a label tape from a label roll 12, e.g., a first layer of the label tape from the label roll 12. It is also possible that the apparatus 10 moves the label tape to a treatment device (e.g., an adhesive tape dispenser, bonding device), preferably in a force-controlled manner, so that the label tape is not stretched excessively. It is also possible that the apparatus 10 supports cut-mark recognition and thus the correct positioning of an adhesive strip on the label tape, e.g., in conjunction with an (external) adhesive tape dispenser. For example, the apparatus 10 can also provide support in cutting the label tape in the correct position and transferring it to a bonding device and/or removing a cut-off tape remnant.

The apparatus 10 has a shaft 14 and a base body 42. The shaft 14 and the base body 42 can preferably form a lower part of the apparatus 10. The apparatus 10 can furthermore, for example, have an upper part 66.

The shaft 14 is used to roll up (wind) an (initial) portion of the label tape from a label roll 12. The label tape can be held using the shaft 14 on the portion rolled up onto the shaft 14.

FIG. 1 shows in this connection a preferred embodiment of a label roll 12 prepared for handling using the apparatus 10. Here, FIG. 1 shows a state during the preparation before the bonding of the label roll 12.

Preferably, the (initial) portion of the label tape can be secured (e.g., by the manufacturer) using a double-sided adhesive tape K, so that the leading end portion protrudes over this adhesive tape K by a distance a. Thus, the adhesive tape K can be arranged at a distance a from a leading end edge of the label tape. The distance a can, for example, be a few centimeters, e.g., between 30 mm and 40 mm.

Preferably, the adhesive tape K can also be arranged at a distance from a top edge and/or a bottom edge of the label tape. For example, the distance b to the top edge can be between 1 mm and 5 mm. The distance c to the bottom edge can be between 1 mm and 5 mm.

Preferably, the adhesive tape K can have two sides having different adhesive strengths. In this way, it could be ensured that the adhesive tape K remains on the desired side when the leading end of the tape is pulled off, e.g., at the leading end of the tape and not on the label roll 12.

Referring again to FIG. 2 et seq., the shaft 14 can preferably have a total length ≥200 mm and/or ≤300 mm. Preferably, at least label tapes with tape heights between 20 mm and 200 mm can be wound using the shaft 14.

For example, the shaft 14 can have an outer diameter ≥50 mm and/or ≤100 mm, e.g., approximately 80 mm or less. Advantageously, such a small outer diameter can result in a low mass moment of inertia, which in turn can be advantageous for controlling the tape force. Under normal conditions, approximately eight revolutions of the shaft 14 are thus required with such an outer diameter (600 mm roller outer diameter/80 mm shaft diameter=7.5 shaft revolutions) in order to roll up a first layer of the label roll 12 onto the shaft 14. The multiple or multi-layer wrapping of the shaft 14 can advantageously support a secure fixation of the label tape on the shaft 14.

Preferably, the shaft 14 can be made of a lightweight material, e.g., an aluminum alloy or a plastic. Advantageously, this can in turn minimize a mass moment of inertia. It is also possible to configure the shaft 14 completely, substantially completely, or partially as a 3-D printed part (additively manufactured part from a plurality of adjacent material layers), wherein, here, functional integration, weight reduction, and cost optimization can be particularly advantageous.

Preferably, the shaft 14 can be provided with a non-stick coating on its outer face/outer circumferential face. Thus, advantageously, bonding with adhesive tape for tape fixation or its adhesive residues can be avoided. The non-stick coating can, for example, be a ceramic or plastic coating.

Preferably, the shaft 14 has a longitudinal gap 16. The longitudinal gap 16 can receive the leading end of a portion of the label tape. Preferably, the leading end can be held in the longitudinal gap 16 in any conceivable way, e.g., by clamping and/or suction. For example, the longitudinal gap 16 can be configured as a longitudinal suction gap and/or longitudinal clamping gap.

The longitudinal gap 16 can preferably extend parallel to a longitudinal axis of the shaft 14. The longitudinal gap 16 can, for example, have a total length ≥200 mm and/or ≤300 mm.

Preferably, the shaft 14 has a shoulder 18 at its free (lower) end. The shoulder 18 can encircle the shaft 14 completely or only in certain portions. Using the shoulder 18, the label tape can be prevented from running off or slipping off the shaft 14. One longitudinal edge of the label tape, e.g., the lower longitudinal edge, can be supported on the shoulder 18. The label tape can, for example, be guided along the shoulder 18 when being rolled up onto the shaft 14.

Preferably, the shaft 14 is rotatably mounted only at one end, viz., opposite its free end. For example, the shaft 14 can be rotatably mounted in a carrier body 70, preferably a plate-shaped carrier body, e.g., using deep-groove ball bearings. The carrier body 70 can carry the shaft 14 on the upper part 66.

Preferably, the shaft 14 can be a hollow shaft in which, for example, different devices can be arranged.

A drive unit 20 of the apparatus 10 can be connected to the shaft 14 in a driving manner for rotating the shaft 14 around a central longitudinal axis of the shaft 14. The drive unit 20 can preferably be arranged in the upper part 66 of the apparatus 10. The drive unit 20 can, for example, be carried on a carrier body 72 of the upper part 66.

The drive unit 20 is preferably an electric drive unit, e.g., a servo motor. Preferably, the drive unit 20 can be connected to the shaft 14 via a transmission connection 22. The transmission connection 22 can, for example, have a planetary and/or angle gearbox (e.g., a 90°-angle gearbox). Alternatively or additionally, the transmission connection 22 can, for example, have a cycloidal gearbox, a belt drive, or any other suitable gearbox.

Alternatively, the drive unit 20 can be directly connected to the shaft 14. For example, tape force measurement could then be easily made possible via a motor current of the drive unit 20. Here, a gearbox between the drive unit 20 and the shaft 14 would be rather disadvantageous (friction, play). On the other hand, if an extra sensor (e.g., force-torque sensor or force sensor) is used for optional tape force measurement, the transmission connection 22 would be more advantageous, since the drive unit 20 could be kept smaller.

The drive unit 20 can make it possible for the shaft 14 to rotate in both rotational directions, and this independently of any movement, e.g., rotation, of the entire apparatus 10 on, for example, a robot arm.

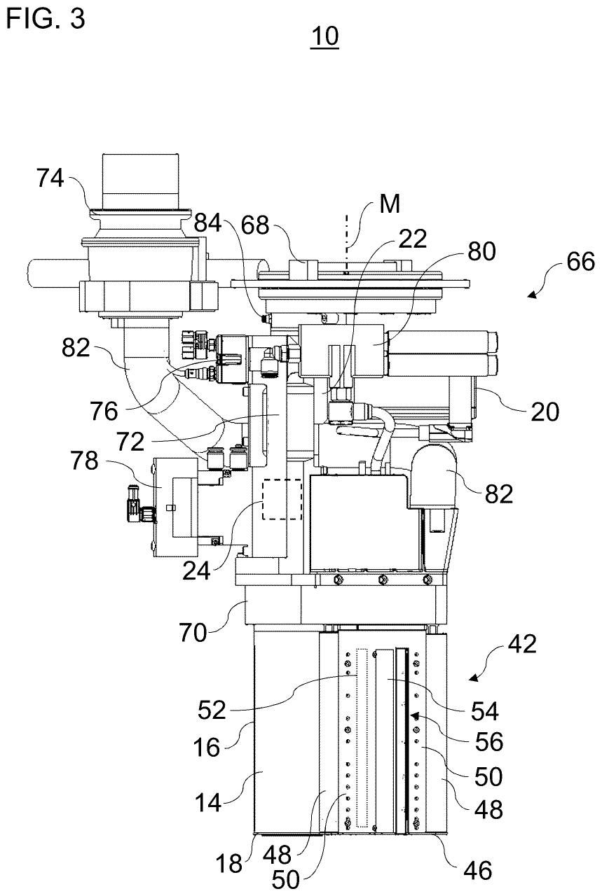

The drive unit 20 can preferably be connected to the shaft 14 via a compensating coupling 24 (hidden in the figures and therefore only shown as a dashed line in FIG. 3). The compensating coupling 24 can, for example, be an axle offset and/or angle offset compensating coupling. Preferably, the compensating coupling 24 is a bellows coupling. For example, the compensating coupling 24 can be arranged between the transmission connection 22 and the shaft 14.

A suction device 26, a clamping device 32, and/or a tape sensor 40 can preferably be arranged in or on the shaft 14.

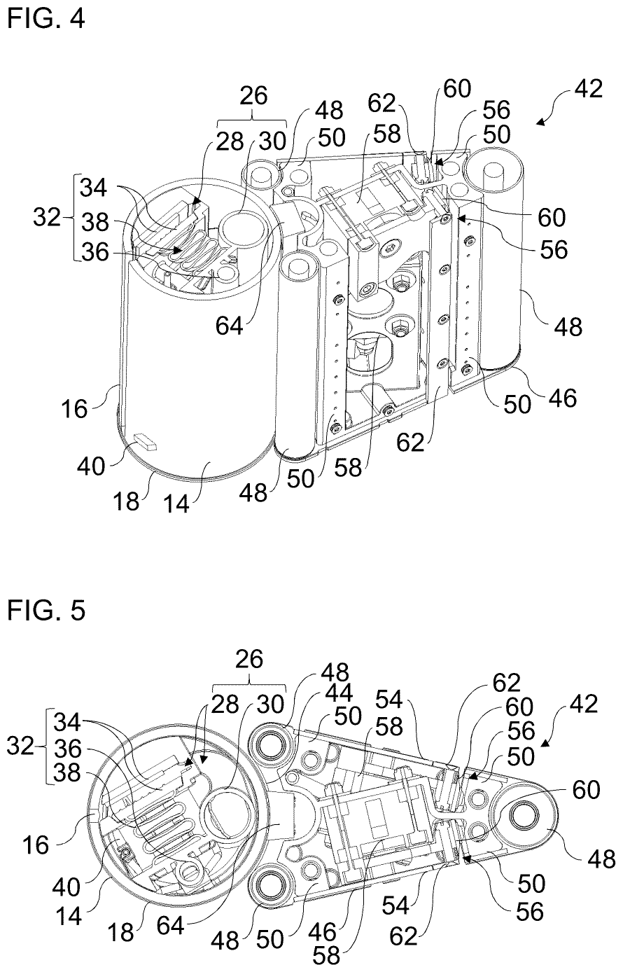

The suction device 26 can be provided for drawing in the label tape to and/or into the shaft 14 (see in particular FIGS. 3 and 4). The suction device 26 is preferably arranged in the (hollow) shaft 14. The suction device 26 can be connected to the shaft 14 in a rotationally fixed manner and rotate with the shaft 14.

For example, the suction device 26 can have a suction nozzle 28. The suction nozzle 28 can be arranged in the shaft 14. The suction nozzle 28 can extend substantially along the entire length of the shaft 14, for example. Using the suction nozzle 28, the leading end of a label tape can be sucked into the suction nozzle 28. The suction nozzle 28 can preferably open in the longitudinal gap 16. In other words, the longitudinal gap 16 can be an inlet opening to the suction nozzle 28, through which a leading end of the label tape can be sucked into the suction nozzle 28.

It is possible that the suction device 26 has a vacuum line (vacuum-applied line) 30. The line 30 can, for example, have a tubular shape. A longitudinal axis of the line 30 can preferably run parallel and spaced apart from a central longitudinal axis of the shaft 14. The line 30 can be connected, on the one hand, to the suction nozzle 28 for drawing in air. On the other hand, line 30 can be connected to a vacuum supply, e.g., in the region of the carrier body 70. Preferably, the vacuum supply is not carried out via a rotary distributor, but via a through-passage between two rotary bearings for the shaft 14 at an end portion of the shaft 12. Advantageously, a particularly large line cross-section can thus be achieved easily. Alternatively, a rotary distributor could be used.

It is possible that the suction device 26 can be supported, for example, by at least one compressed air nozzle on the apparatus 10. For example, at least one compressed air nozzle can be arranged on the outside of the apparatus 10. For example, at least one compressed air nozzle can blow the tape into the longitudinal gap 16 from the outside, i.e., apply compressed air to move it toward the longitudinal gap 16 and/or to move it into the longitudinal gap 16.

The clamping device 32 can be provided for clamping the label tape in and/or on the shaft 14 (see in particular FIGS. 3 and 4). The clamping device 32 is preferably arranged in the (hollow) shaft 14. The clamping device 32 can be connected to the shaft 14 in a rotationally fixed manner and rotate with the shaft 14.

Preferably, the clamping device 32 can clamp a leading end of the label tape that has been sucked into the shaft 14. Preferably, the clamping device 32 can extend substantially along the entire length of the shaft 14.

The clamping device 32 can, for example, have two clamping elements 34 that are movable relative to one another. The clamping elements 34 can, for example, be configured as clamping plates. The leading end of the label tape that has been sucked in can be clamped between the clamping elements 34. Preferably, the clamping elements 34 can be at least partially profiled and/or elastically compressible.

The clamping elements 34 can preferably be aligned with or merge into the longitudinal gap 16. A space between the clamping elements 34 can preferably form a portion of the suction nozzle 28.

Preferably, the clamping device 32 can be pneumatically actuated. For example, compressed air can be fed to a pneumatic clamping actuator 38 of the clamping device 32 via a compressed air line 36 of the clamping device 32. The clamping actuator 38 can, for example, be an inflatable bellows or a pneumatic cylinder. The clamping actuator 38, which is acted upon by compressed air, can press one of the clamping elements 34 against the other clamping element for clamping the leading end of the label tape.

The compressed air line 36 can be connected to a compressed air supply, e.g., in the region of the carrier body 70. For example, a rotary distributor can be connected to the compressed air line 36 here. As an alternative to a rotary distributor, the passage of the compressed air can, for example, be carried out via a separable connection such as a plug-type connection. This can be temporarily connected, for example, using a cylinder-piston unit, from the stationary part of the apparatus 10 to the shaft 14 and the clamping device 32 therein. The cylinder-piston unit can, for example, be arranged in the carrier body 70. This variant is possible if the corresponding functionalities are required only when shaft 14 is stationary.

The tape sensor 40 can preferably detect if the shaft 14 is holding a label tape. The tape sensor 40 can particularly preferably detect if a portion of the label tape protrudes through the longitudinal gap 16 into the shaft 14.

The tape sensor 40 can be connected to the shaft 14 in a rotationally fixed manner. The tape sensor 40 is, for example, an optical sensor, e.g., a laser sensor or an LED sensor. The tape sensor 40 can, for example, be a light barrier. Preferably, the tape sensor 40 can be arranged in the shaft 14.

For example, the tape sensor 40 can be arranged in a free end region of the shaft 14. It may be sufficient to arrange the tape sensor 40 only in the free end region of the shaft 14, since label tapes having different heights can always be rolled up onto the shaft 14 in a position that rests against and is guided by the shoulder 18. When received using the shaft 14, the lower edge of the label tape is thus always arranged at the lower edge of the longitudinal gap 16, where the tape sensor 40 can also be arranged.

Electrical signals from and/or to the tape sensor 40 can be passed, for example, via a rotary distributor (e.g., a slip-ring transmitter) in the carrier body 70. Alternatively, the signals can also be passed via a separable connection, such as a plug-type connection, as already explained for compressed air.

The base body 42 serves to apply a portion of the label tape adjacent to the portion of the label tape rolled up onto the shaft 14. The base body 42 can thus serve as a fixed opposite face for handling and, if necessary, treating the label tape. For this purpose, the label tape, after being rolled up in certain portions onto the shaft 14 and optionally secured in or on it, can be guided and laid by a movement of the entire apparatus 10 around the base body 42. This movement of the entire apparatus 10 can preferably be effected by a robot arm movement. Here, it is particularly advantageous that, by selecting a direction of rotation of the entire device 10, either the outer side or the inner side of the label tape can be placed against the base body 42. Preferably, both sides of the label tape can thus be brought into a processing position in a simple manner.

The base body 42 is arranged next to the shaft 14. For example, a longitudinal axis of the base body 42 can extend parallel to a longitudinal axis of the shaft 14. Preferably, the base body 42 has a substantially cylindrical segment-shaped receptacle 44 (see, e.g., FIG. 5) into which the shaft 14 (e.g., a cylindrical segment-shaped portion thereof) is immersed. The base body 42 can encompass (enclose) a jacket portion of the shaft 14 at the receptacle 44, without touching the shaft 14.

Preferably, the base body 42 has a shoulder 46 at its free (lower) end. The shoulder 46 can encircle the base body 42 completely or only in certain sections. Using the shoulder 46, the label tape can be prevented from running off or slipping off the base body 42. One longitudinal edge of the label tape, e.g., the lower one, can be supported on the shoulder 46. The label tape can, for example, be guided along the shoulder 46 when applying it to the base body 42.

Preferably, the shoulders 18 and 46 can be on the same plane. Preferably, the base body 42 and the shaft 14 can terminate flush with one another at the shoulders 18 and 46 at their end sides.

Preferably, the base body 42 can substantially have a triangular prism shape or a quadrilateral prism shape. The base body 42 can, for example, have a substantially triangular cross-section, preferably along its entire length, as can be seen, for example, in FIGS. 4 and 5. Alternatively, the base body 42 can, for example, have a different, preferably polygonal, e.g., square (e.g., rectangular), cross-section.

The base body 42 can have a total length (total height) that can substantially correspond to a total length of the shaft 14, e.g., ≥200 mm and/or ≤300 mm.

The base body 42 can preferably be configured substantially completely or partially as a 3-D printed part (additively manufactured part made of a plurality of adjacent material layers).

Preferably, the base body 42 is supported or carried only at one end side, viz., opposite its free end. For example, the base body 42 can be carried on a carrier body 70. The carrier body 70 can carry the base body 42 on the upper part 66.

Preferably, the base body 42 can have at least one guide roller 48, at least one suction device 50, at least one heating device 52, at least one reflector 54, and/or at least one cutting device 56, 64.

The at least one guide roller 48 is arranged on at least one (longitudinal) edge region of the base body 42 for guiding the label tape around the particular edge region. Advantageously, the guide rollers 48 can significantly reduce frictional forces during the tape run over the base body 42, which can prevent excessively high stress on the label tape, particularly at low tape heights.

Preferably, a plurality of guide rollers 48 are included. If the base body 42 has a substantially triangular (quadrilateral) cross-section and three (four) longitudinal edge regions, a guide roller 48 can preferably be arranged on each longitudinal edge region, i.e., a total of three (four) guide rollers 48 can be included.

Preferably, the at least one guide roller 48 can be rotatably mounted at both of its end sides. The at least one guide roller 48 can allow the label tape to roll over the particular guide roller during its tape run.

A longitudinal axis of the at least one guide roller 48 preferably runs parallel to the longitudinal axis of the shaft 14.

Preferably, the at least one guide roller 48 can be formed from a carbon tube. Advantageously, this can reduce a mass moment of inertia and thereby make fast handling of the label tape possible.

Preferably, the at least one guide roller 48 projects beyond adjacent side faces of the base body 42, e.g., in a range between 0.5 mm and 1 mm. Advantageously, during normal handling, the label tape can substantially lie against the at least one guide roller 48 in the region of the base body 42.

It is also possible that, alternatively or in addition to the at least one guide roller 48, another type of deflection element, e.g., a sliding element, such as a sliding guide, is included. In general, at least one deflection element can prevent the tape force from increasing undesirably during a tape deflection. When detecting the tape force, this friction force might, depending upon the measurement principle, not be measured and could thus lead to the tape tearing.

The at least one suction device 50 can additionally hold and fix the label tape that rests against the base body 42. Preferably, the at least one suction device 50 can also hold a loose tape remnant after the label tape has been cut, e.g., during a transfer to a bonding device of a labeling system.

The at least one suction device 50 is arranged on at least one side face of the base body 42. For example, the base body 42 can have two side faces, each having at least one suction device 50. For example, at least one suction device 50 can be arranged adjacent to a guide roller 48.

In the exemplary embodiment shown in FIGS. 2 to 11, for example four suction devices 50 are included on opposite sides of the base body 42, which are preferably arranged adjacent to the three guide rollers 48.

The at least one suction device 50 preferably has a vacuum bar. A vacuum bar can, for example, have a plurality of suction openings. The suction openings can be spaced apart along a length of the vacuum bar.

The at least one heating device 52 is shown schematically with a dotted line in FIGS. 2 and 3. The at least one heating device 52 can, for example, be arranged adjacent to the at least one suction device 50. Preferably, the at least one heating device 52 can be an electric heating device.

In the exemplary embodiment shown in FIGS. 2 to 11, for example, two heating devices 52 are included on opposite sides of the base body 42.

For example, a particular side face (e.g., side plate) of the base body 42 can be heated using at least one heating device 52. Preferably, the at least one heating device 52 is arranged precisely at the location behind the particular side face at which an adhesive application or an application of an adhesive tape to the label tape takes place. Advantageously, heating allows the adhesive to be applied to the label tape in a process-reliable and rapid manner.

Preferably, the at least one reflector 54 can serve for print mark recognition in a transparent label tape. For example, at least one reflector 54 can be configured as a reflector tape. For example, a longitudinal axis of the reflector tape can run parallel to a longitudinal axis of the shaft 14.

The at least one reflector 54 can, for example, be arranged adjacent to the at least one cutting device 56 and/or the at least one suction device 50.

In the exemplary embodiment shown in FIGS. 2 to 11, for example, two reflectors 54 are included on opposite sides of the base body 42.

The at least one cutting device 56 serves to cut off the label tape resting against the base body 42, e.g., at the end of the handling process. Preferably, two cutting devices 56 are included on opposite sides of the base body 42.

FIGS. 7 to 10 show a cutting device 56 in isolation.

A cutting device 56 preferably has a cutting actuator 58 and a cutting blade 60 and optionally a transfer bar 62.

Preferably, the cutting actuator 58 is a pneumatic actuator, e.g., a pneumatic cylinder. The cutting actuator 58 can be connected to the cutting blade 60 for retracting and extending the cutting blade 60. Preferably, the cutting blade 60 is in a retracted state if the cutting actuator 58 is deactivated, e.g., is not pressurized with compressed air. The cutting actuator 58 can, for example, have a retractable piston that is connected to the cutting blade 60 for extending and retracting the cutting blade 60.

The cutting blade 60 can preferably be arranged next to a suction device 50 and/or next to the transfer bar 62. Preferably, a longitudinal axis of the cutting blade 60 can extend parallel to the central axis of the shaft 14.

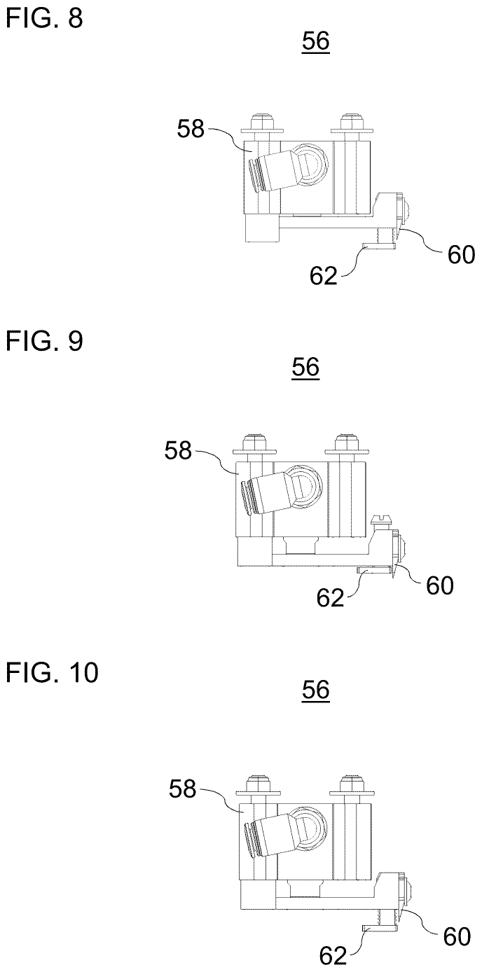

As already mentioned, the cutting blade 60 can be retracted and extended. FIG. 8 shows by way of example the retracted position. FIGS. 9 and 10 show the extended position by way of example. FIG. 9 shows the transfer bar 62 in the loaded state (opposite face not shown) when the label tape is cut using the cutting blade 60. FIG. 10 shows the transfer bar 62 in the unloaded state, e.g., after the label tape has been cut when the apparatus 10 is moved away from the opposite face (opposite face not shown).

In the retracted state, the cutting blade 60 preferably does not protrude beyond an assigned side face of the base body 42 (e.g., the suction device 50) and/or the transfer bar 62 (see FIG. 8). Advantageously, there is thus no risk of injury. In the extended state, the cutting blade 60 can preferably project beyond an assigned side face of the base body 42 (e.g., the suction device 50) and/or the transfer bar 62 (see FIGS. 9 and 10).

The transfer bar 62 preferably serves to support the tape transfer at the end of the handling process, e.g., to a bonding device of a labeling system. Preferably, a longitudinal axis of the transfer bar 62 can extend parallel to the central axis of the shaft 14.

Preferably, the transfer bar 62 can be elastically mounted and thus be displaceable or pressable against the elastic mounting. For example, the transfer bar 62 can be elastically mounted and, optionally, carried by a plurality of springs, such as coil springs. The springs can make the elastic movement of the transfer bar 62 perpendicular to the longitudinal axis of the transfer bar 62 possible.

Particularly preferably, the transfer bar 62 can have a non-stick coating, e.g., a ceramic or plastic coating. Advantageously, this can prevent adhesive strips that can lie against the transfer bar 62 together with the label tape for transfer, e.g., to a bonding device of a labeling system, from sticking.

It is additionally or alternatively conceivable for the transfer bar 62 to have a recess in certain regions. Preferably, the transfer bar 62 should not come into contact with the adhesive at all.

It is possible that the base body 42 also comprises a cutting device 64, as shown by way of example and schematically in FIGS. 4 and 5. The cutting device 64 can be arranged directly opposite the shaft 14. The cutting device 64 can also be referred to as an internal cutting device.

The cutting device 64 can have an extendable and retractable cutting blade and a cutting actuator, preferably pneumatic, for extending and retracting the cutting blade (not shown in detail in FIGS. 4 and 5).

Preferably, the cutting blade can extend in the direction of the shaft 14 for cutting a label tape (e.g., wound onto the shaft 14) running between the cutting device 64 and the shaft 14. Particularly preferably, the shaft 14 can be rotated before the cutting blade is extended such that the cutting blade can be extended (immersed) into the longitudinal gap 16 of the shaft 14.

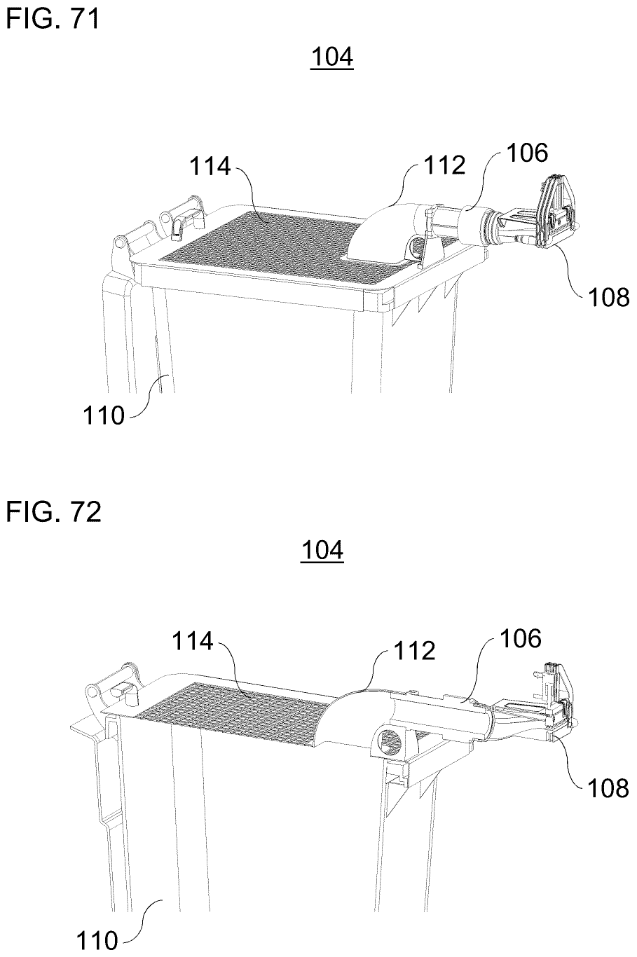

Advantageously, the cutting device 64 can thus cut a label tape remnant on the shaft 14. At the end of the handling process, a plurality of tape layers, which may have adhered to one another due to double-sided adhesive tape or adhesive residues, can still be present on the shaft 14. By splitting the tape layers, the label tape remnant can be removed more easily from the shaft 14. It is also possible to remove the tape or the cut tape using an apparatus provided for this purpose (see, for example, FIGS. 71 and 72 with accompanying description).

The upper part 66 can make a connection of the shaft 14 and the base body 42 with a robot arm of a robot possible.

Preferably, the upper part 66 has a support flange 68 for the load-bearing attachment of the apparatus 10 to a support flange of a robot arm. The support flange 68 can be connected in a load-bearing manner to the shaft 14 and the base body 42 via at least one carrier body 70, 72. The shaft 14 and the base body 42 can be carried on the support flange 68 and thus on the robot arm via the at least one carrier body 70, 72.

Preferably, the support flange 68 can be connected to the support flange of the robot using an automatic quick-change system. In this way, a change can be made to another gripper type (e.g., a label roll gripper) when needed, without any operator intervention.

Preferably, a central axis M of the support flange 68 is offset, preferably parallel offset, to a central axis of the shaft 14. Preferably, the robot arm, on which the apparatus 10 is attached via the support flange 68, can be rotated for rotating the apparatus 10 around the central axis M.

Preferably, the upper part 66 also has a pneumatic and/or electrical connection interface 74 for connecting a robot drag chain having at least one supply line. The at least one supply line can be guided within the robot drag chain. For example, it can comprise at least one electrical and/or at least one pneumatic supply line.

The upper part 66 can have various devices and components. For example, the upper part 66 can have the drive unit 20, the transmission connection 22, the compensating coupling 24, an input/output module 76, a valve manifold 78, at least one Venturi nozzle 80, a vacuum line 82, and/or a sensor 84.

The input/output module 76 and the valve manifold 78 of the upper part 66 make it possible to reduce the number of lines that have to be laid through the drag chain of the robot to a minimum.

The input/output module 76 can, for example, have at least one electrical supply connection for connecting an electrical supply line and at least one communications connection for receiving communication signals. The input/output module 76 can be connected, for example, to the drive unit 20, the tape sensor 40, the cutting device(s) 56, 64, the valve manifold 78, and/or the sensor 84.

The valve manifold 78 can have a plurality of pneumatic valves for switching the pneumatic functions of the apparatus 10. For example, using the pneumatic valves, the clamping device 32, and/or the cutting device(s) 56, 64 can be actuated, and the at least one Venturi nozzle 80 can be supplied with compressed air.

The at least one Venturi nozzle 80 is preferably connected to the valve manifold 78 and the at least one suction device 50. The at least one Venturi nozzle 80 can serve to generate a negative pressure or vacuum for the at least one suction device 50. This at least one suction device 50 preferably requires a relatively high negative pressure at a relatively low volume flow rate. Preferably, at least two Venturi nozzles 80 are included, which can be arranged, for example, on opposite sides of the base body 42.

The vacuum line 82 can preferably connect the connection interface 74 and the suction device 26 to one another. The vacuum line 82 can, for example, run in certain portions through the carrier body 70 and be connected to an inlet portion of the line 30 of the suction device 26. The vacuum line 82 can preferably be connected to a vacuum source, which is provided separately from the apparatus 10 and, for example, the robot carrying the apparatus 10. For example, the vacuum source can have a side channel blower and/or a volume flow amplifier. The vacuum line 82 preferably has a relatively large cross-section. The suction device 26 can require a relatively low negative pressure at a relatively large volume flow rate.

The sensor 84 is arranged to detect forces and/or moments acting upon the apparatus 10 and/or the shaft 14. The sensor 84 can, for example, be arranged adjacent to the support flange 68, as shown by way of example in FIGS. 2 and 3. Alternatively, the sensor 84 could, for example, be arranged in or on a drive connection between the shaft 14 and the drive unit 20, or measure motor currents of the drive unit 20. Other arrangements on or in the apparatus 10 are also conceivable.

For example, when handling narrow label tapes, they must not be subjected to excessive loading or stretching. Nevertheless, a certain amount of force must be applied in order to prevent the label tape from sagging. For example, with tape heights in the range of 20 mm-35 mm, a tape force can preferably be approximately 5 N-10 N.

Using the sensor 84, a magnitude and a direction of the tape force can preferably be detected when moving/traversing the apparatus 10 and thus the label tape held by it, since otherwise, for example, no relevant forces would act here. The measured values can be taken into account in an adaptation, preferably a control, of the tape force. This adaptation can substantially be performed by the drive unit 20. Alternatively or additionally, it is possible, for example, to adapt, preferably control, the tape force using a label roll receptacle, e.g., a film plate, on which the label roll is received.

Accordingly, the drive unit 20 can be configured to drive the shaft 14 in a force-controlled manner when moving the entire apparatus 10, depending upon the load on the shaft 14 and/or on the apparatus 10 detected using the sensor 84, in order to apply a tape force to the label tape. This function can also be referred to here as tape force control. As mentioned, this can prevent, for example, sagging and damage to the label tape.

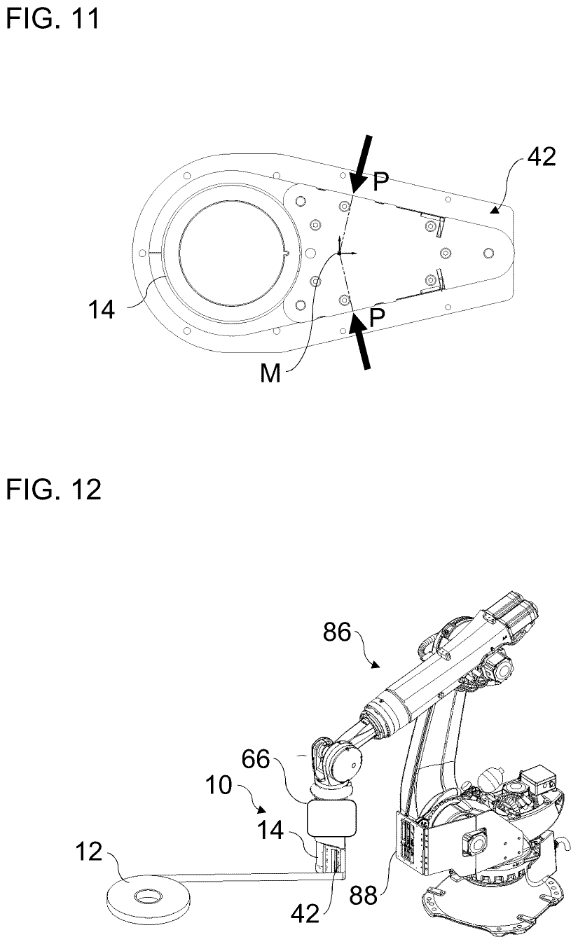

FIG. 11 shows by way of example that positions P for the application of the adhesive (e.g., adhesive strips) to the label tape on the sides (e.g., side plates) of the base body 42 are preferably positioned so that the adhesive application direction can run exactly through the central axis M. Applying the adhesive tape preferably requires a relatively high contact force, which in the arrangement shown does not lead, or at least not significantly lead, to an unwanted moment on the apparatus 10, the sensor 84, and the connected robot arm.

Furthermore, this arrangement makes it advantageous to implement an adhesive tape dispenser attached to the robot that pivots with the first robot axis (see also FIG. 12). Due to the lack of a degree of freedom of the robot with respect to the adhesive dispenser, the vertical line at the application point must pass through the extension of the central axis of the robot, since the robot cannot displace the apparatus 10 to the adhesive tape dispenser laterally here.

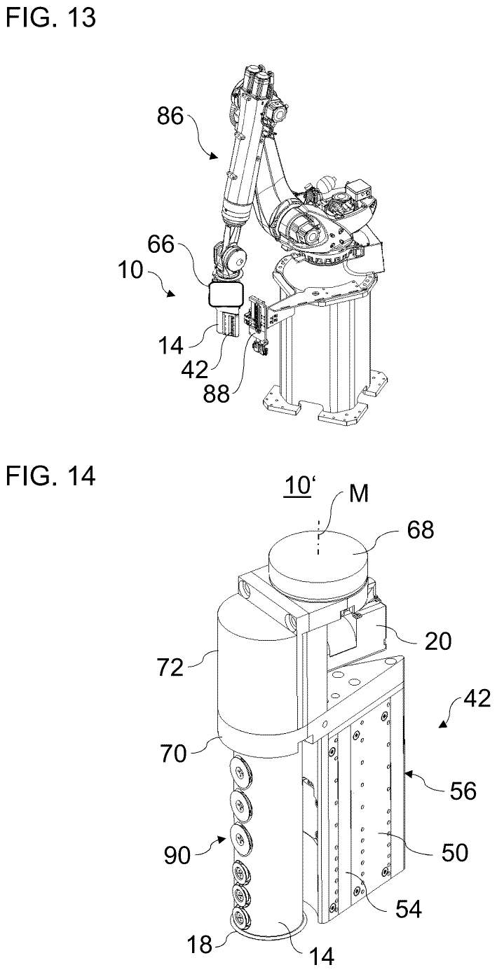

FIGS. 12 and 13 show the apparatus 10 carried as an end effector on a robot 86, preferably configured as an articulated-arm robot.

The robot 86 preferably also has an adhesive tape dispenser 88 for dispensing an adhesive strip onto the label tape resting against the base body 42. Preferably, the adhesive tape dispenser 88 can be attached to a movable axis (e.g., the main axis of rotation) of the robot 86 (see FIG. 12) or to a stationary base (e.g., a pedestal) of the robot 86 (see FIG. 13).

The variant shown by way of example in FIG. 12, with the adhesive tape dispenser 88 pivoting along with the robot 86, can be particularly advantageous. For example, if the working height of the shaft 14 and the base body 42, and thus of the adhesive tape dispenser 88, is at robot level, the robot 86 can pivot freely without the risk of collision as with a stationary dispenser. The adhesive tape dispenser 88 can be aligned using the robot 86 toward the particular label roll receptacle (or other storage locations for the label rolls), e.g., in order to achieve an optimal tape run. This is particularly advantageous if a large number of different positions have to be visited.

If the working height of the shaft 14 and the base body 42 is far below the robot level, a non-pivoting adhesive tape dispenser 88, as shown in FIG. 13, is rather advantageous, since, for example, pivoting in the region of the wiring of the robot base does not cause any problems. It is possible that the adhesive tape dispenser 88 is attached in a stationary manner on the robot 86 and can optionally be moved with an additional drive.

The adhesive tape dispenser 88 can also be replaced by another device, or the application of the adhesive strip can be carried out by the particular machine and not by the robot 86. The same applies to tape cutting using the optional cutting device(s) 56, 64.

FIG. 14 shows a simplified representation of a modified apparatus 10′.

For example, the shaft 14 can have a bellows suction gripper 90. Advantageously, the shaft 14 can be configured to be relatively compact and does not require a separate vacuum source, since a Venturi nozzle can be sufficient for the low volume flow rate of the bellows suction gripper 90. Since relatively little force can be applied via the bellows suction gripper 90, the leading end of the tape of the label roll 12 could, for example, be secured here using a pre-perforated sticker.

It is conceivable that the shaft 14, for example, not have a suction nozzle 28 for sucking in a leading end of the tape. Instead, the leading end of the tape could, for example, be detected by a camera and then approached, aligned, and clamped in a targeted manner. The leading end of the tape could then preferably also be additionally secured to shaft 14, e.g., using a single-sided adhesive tape with a pull tab.

It is also conceivable that an alternative embodiment of the clamping device be included. For example, the leading end of the tape could be secured using a needle gripper, rotating rollers, or electrostatic force.

The base body 42 of the apparatus 10′ can, for example, be free of guide rollers for the label tape. Alternatively or additionally, it is possible that the cutting device 56 is arranged at one of the tips/edges, facing away from the shaft 14, of the base body 42.

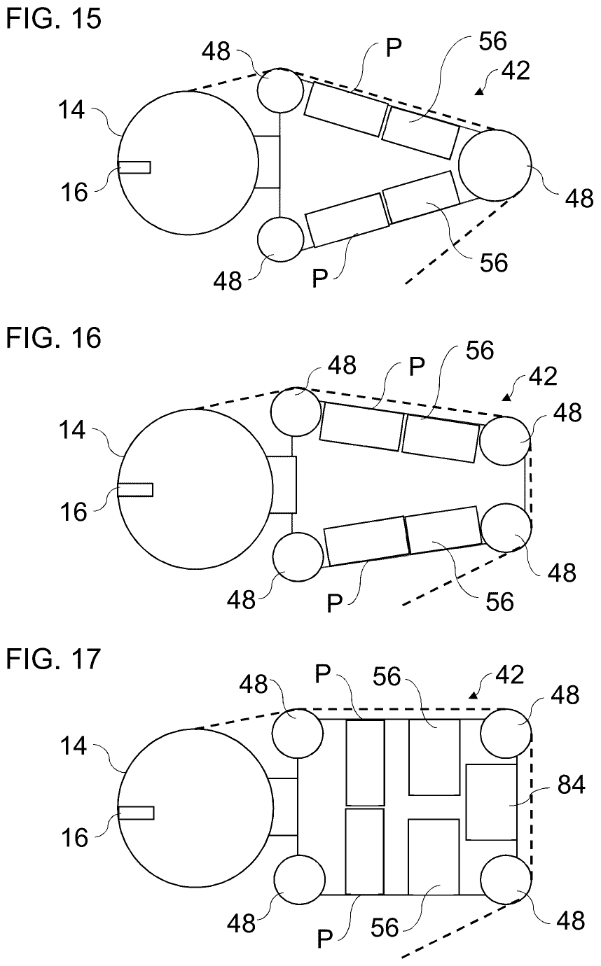

FIGS. 15 to 22 show different embodiments of the base body 42 of the apparatus 10 with an additional representation of the label tape in a dashed line.

For example, different embodiments of the base body 42 can have different basic shapes and/or a different number of guide rollers 48. For example, the base body 42 can have a rectangular shape, preferably with a guide roller 48 in each of the four corners. This results in more installation space being available in the base body 42. It is also possible to vary the arrangement and/or number of the functional devices (e.g., a suction device 50, a heating device 52, a reflector 54, a cutting device 56, 64) of the base body 42. For example, a cutting device 56 can be arranged at the tip of a base body 42 that has a triangular cross-section. The heating device 52 can be omitted, e.g., if the (partial) machine to be fitted with the label tape by the apparatus 10 has an integrated adhesive tape dispenser. Even the cutting device 56 could be omitted, e.g., if the (partial) machine to be equipped has its own cutting device.

FIG. 15 shows a schematic representation of a preferred exemplary embodiment corresponding to the variant explained in detail in FIGS. 2 to 13, i.e., having a substantially triangular cross-section and three guide rollers 48.

FIG. 16 shows a schematic representation of an exemplary embodiment in which the base body 42 has a substantially trapezoidal cross-section and four guide rollers 48.

FIG. 17 shows a schematic representation of an exemplary embodiment in which the base body 42 has a substantially rectangular cross-section, four guide rollers 48, and a sensor 84. For example, the sensor 84 can be arranged on one side, opposite the shaft 14, of the base body 42.

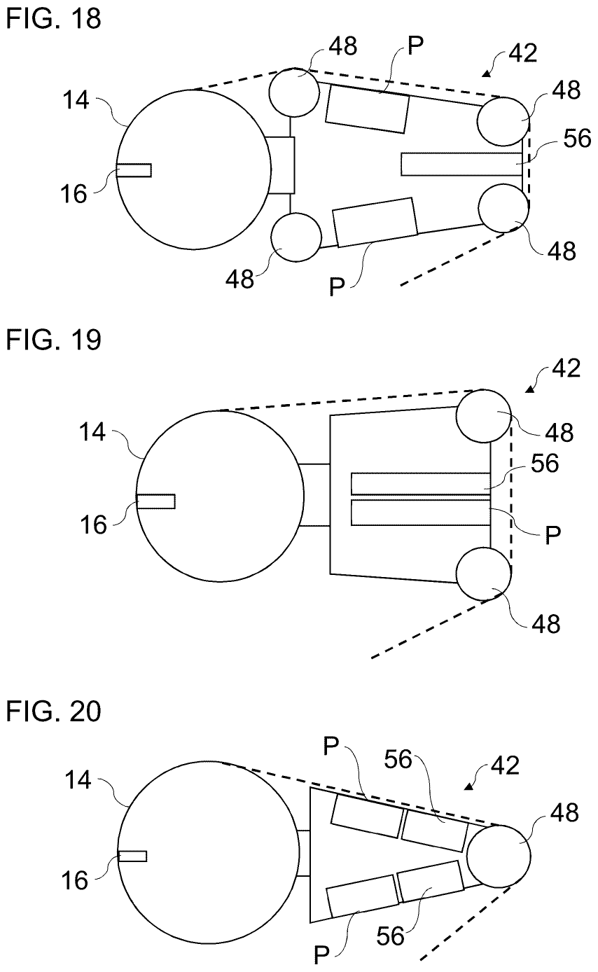

FIG. 18 shows a schematic representation of an exemplary embodiment in which the base body 42 has a substantially trapezoidal cross-section and four guide rollers 48. For example, the cutting device 56 can be arranged on one side, opposite the shaft 14, of the base body 42.

FIG. 19 shows a schematic representation of an exemplary embodiment in which the base body 42 has a substantially trapezoidal or rectangular cross-section and two guide rollers 48. For example, the cutting device 56 and the adhesive application position P can be arranged on one side, opposite the shaft 14, of the base body 42.

FIG. 20 shows a schematic representation of an exemplary embodiment in which the base body 42 has a substantially triangular cross-section and only one guide roller 48. For example, the guide roller 48 can be arranged at one of the tips/edges, opposite the shaft 14, of the base body 42.

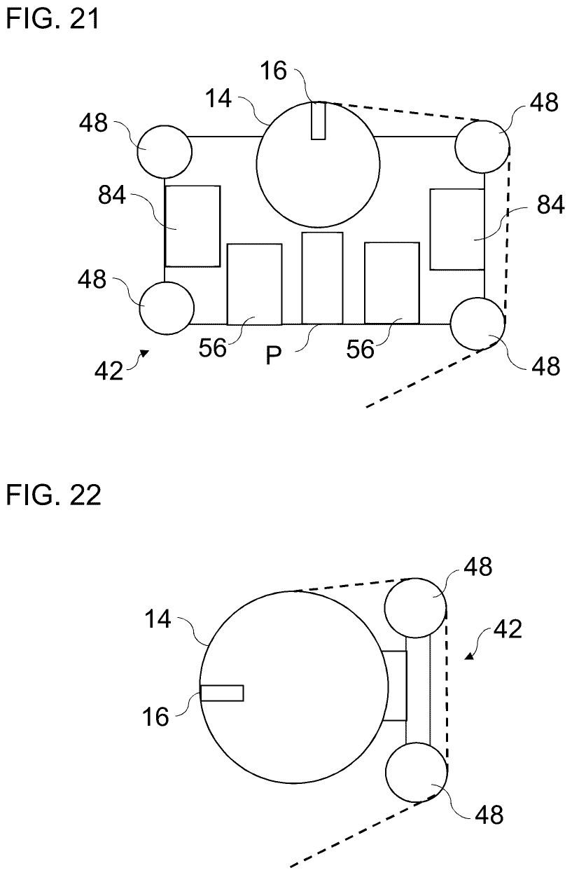

FIG. 21 shows a schematic representation of an exemplary embodiment in which the base body 42 has a substantially rectangular cross-section, four guide rollers 48, and two sensors 84. For example, the sensors 84 can be arranged on opposite sides of the base body 42. For example, the cutting devices 56 and the adhesive application position P can be arranged on one side, opposite the shaft 14, of the base body 42.

FIG. 22 shows an exemplary minimal embodiment in which the driven shaft 14 and a fixed, function-free base body 42 are included, optionally having guide roller(s) 48, which serves as a support face/opposite face for treating the label tape.

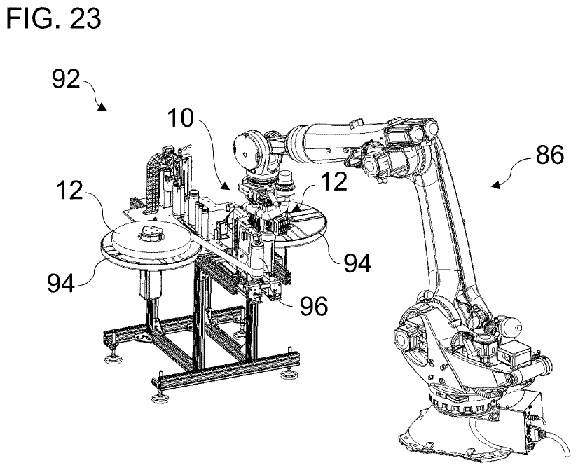

FIG. 23 shows a cutout of a labeling system 92. The labeling system 92 can also have a labeling unit (not shown) for labeling containers. The labeling unit can apply a label from a label tape to the containers conveyed by a (e.g., linear or rotary) container conveyor (also not shown in FIG. 23) as they pass the labeling unit.

Preferably, the labeling system 92 can have two or more label roll receptacles 94 for each receiving a label roll 12 for feeding a label tape to the labeling unit. For example, the label roll receptacles 94 can be configured as rotary tables and/or in each case have a rotatable clamping shaft for a label roll 12. Preferably, the rotary tables can be horizontally aligned, and/or the clamping shafts can be vertically aligned. It is also possible that the label roll receptacles 94 are configured as, preferably vertically aligned, compartments (e.g., inserts) of a label roll storage unit (e.g., multi-reel).

Preferably, the labeling system 92 can further have a bonding device 96 for bonding a leading end of a label tape from one of the label rolls 12 to an end of a label tape from the other label roll 12. Preferably, the bonding device 96 can be configured as a so-called splicing device.

The labeling system 92 can also have the robot 86 with the apparatus 10. The robot 86 can be configured to feed a portion of a label tape from one of the label rolls 12 from one of the two label roll receptacles 94 to the bonding device 96 for bonding to one end of the other label tape. Optionally, the portion can be prepared by the robot 86 or the apparatus 10 for the bonding device 96, preferably cut to size and/or equipped with an adhesive (adhesive tape).

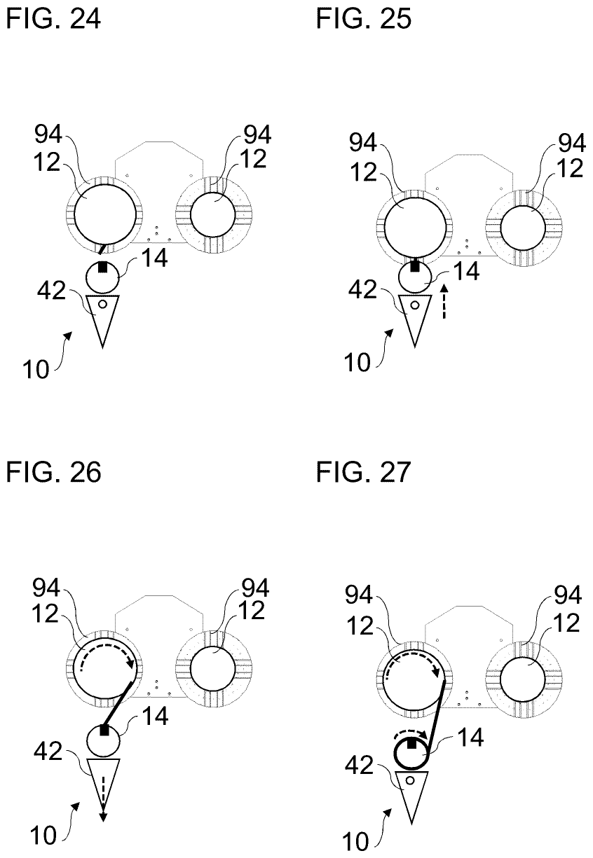

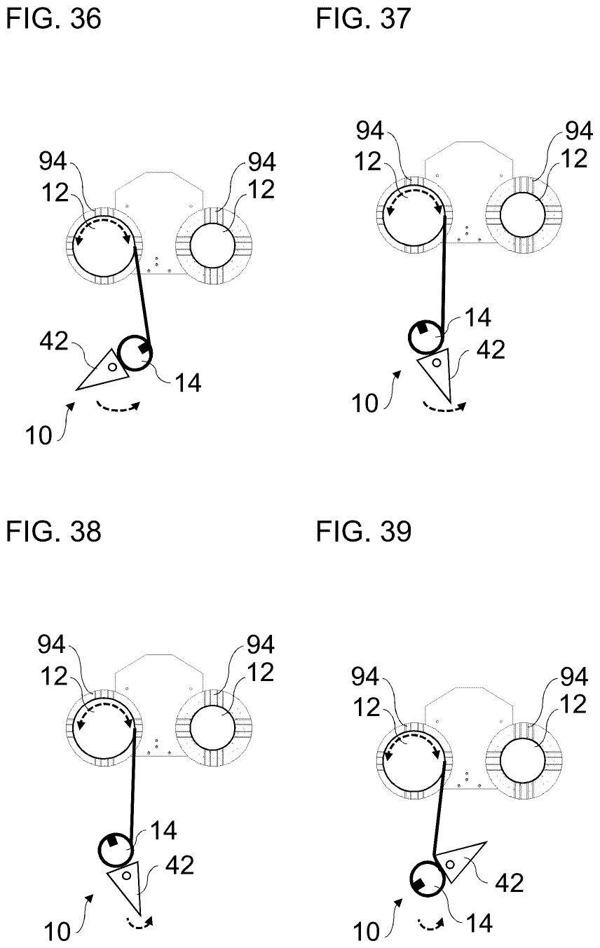

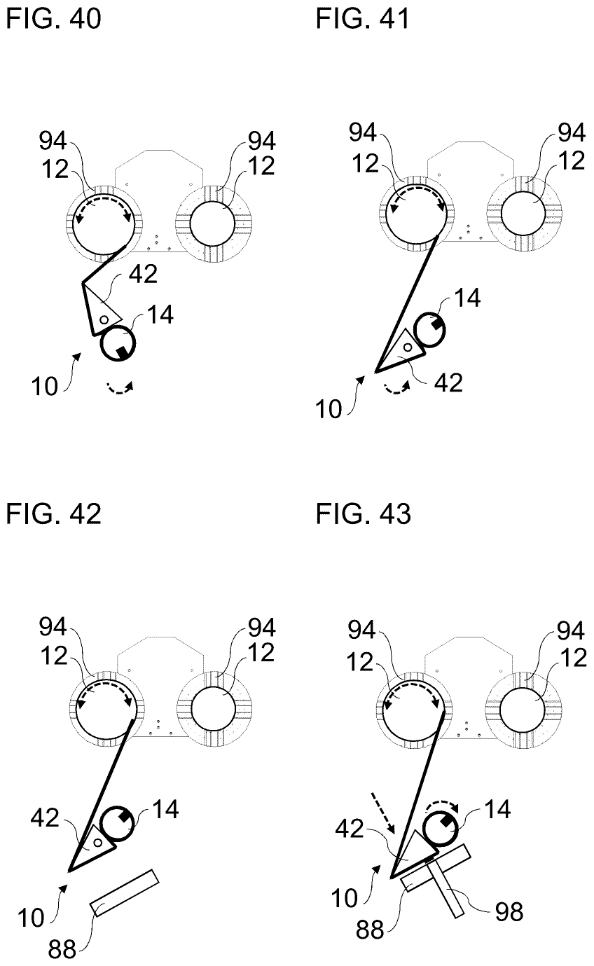

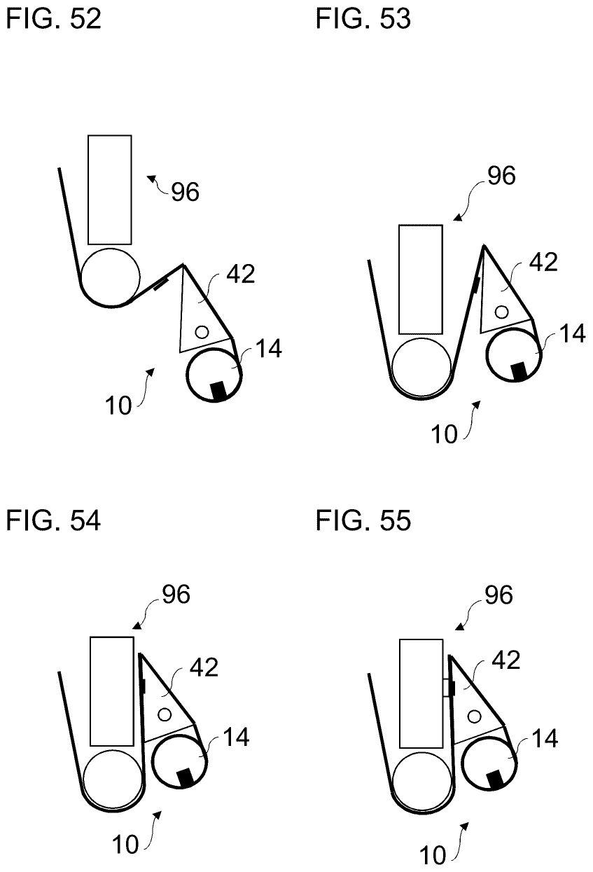

FIGS. 24 to 67 show exemplary methods and method steps that can be performed with the apparatus 10 and/or the robot 86. For clarity, the robot 86 and its robot arm are not shown in any of FIGS. 24 to 67.

Preferably, in the method described below, the force acting upon the label tape can be controlled in such a way as to ensure that the label tape neither sags nor is plastically deformed (stretched) by excessive forces. Here, both a movement of the robot 86 for positioning the label tape in space and a movement (rotation) of the shaft 14 for positioning the label tape relative to the apparatus 10 are preferably taken into account. Preferably, the target force acting upon the label tape can be between 5 N and 10 N.

For example, the force f_ist acting upon the label tape can be measured using the sensor 84. From the target force f_target (e.g., between 5 N and 10 N) and the measured force f_, a force control difference e_f can be determined. The force control difference e_f can be fed to a controller, e.g., with a P-, I-, and/or DT1-element, whose output can be interpreted as an additive tape speed v_f. A tape output speed can be superimposed on the tape speed v_f, which tape output speed can result from a movement of the robot v_R and a movement of the suction shaft v_s. The sum of these speeds can be transmitted, for example, to the particular label roll receptacle 94 as the target speed v_target. Advantageously, this can make the synchronous winding or unwinding of the label tape by the label roll receptacle 94 possible during rotation of the shaft 14 and/or movement of the robot 86. This allows both the robot 86 and the shaft 14 to move advantageously without being influenced by the control system.

FIG. 24 shows a starting position. A new label roll 12 lies on a label roll receptacle 94 (left) and is preferably clamped onto it. The label roll 12 on the other label roll receptacle 94 (right) feeds label tape to the labeling unit. The apparatus 10 can be positioned by the robot arm at the label roll receptacle 94 (left).

FIG. 25 shows how the leading end of the label tape of the label roll 12 (left) can be received by the shaft 14. The apparatus 10 can move with the shaft 14 to just in front of the protruding leading end of the tape and preferably suck it in. The tape sensor 40 (see, e.g., FIG. 4) detects that the suction of the leading end of the tape was successful. The leading end of the tape can be fixed in the shaft 14 by the clamping device 32 (see, e.g., FIG. 4).

FIG. 26 shows how a tape securing means (e.g., adhesive bond, such as double-sided adhesive tape K—see FIG. 1) can be released on the label roll 12 (left). The apparatus 10 can be moved backwards by the robot arm in order to release the tape securing means. Additionally, the shaft 14 can, by rotation, generate a movement of the label tape for releasing the tape securing means.

FIG. 27 shows how at least the first roll layer of the label roll 12 (left) can be wound onto the shaft 14. In this way, dirt and residues of the double-sided adhesive tape can remain wound onto the label tape on the shaft 14. Preferably, the tape force control can be active during winding. Advantageously, the label tape is thus wound tightly onto the shaft 14 without being excessively stretched.

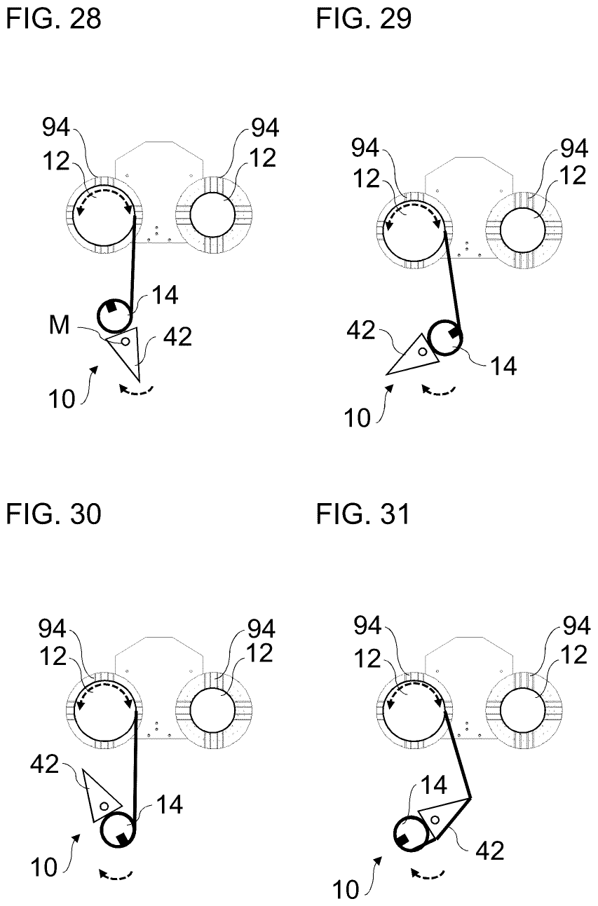

FIGS. 28 to 31 show how an outer side of the label tape can be placed around the base body 42. For example, the tape force control can be active. Preferably, the apparatus 10 can be rotated by approximately 270° by the robot arm, e.g., around the central axis M or the longitudinal central axis of the shaft 14. The label tape can be applied to one side of the base body 42. In the illustrations shown, the apparatus 10 can be rotated so that the label tape lies against the base body 42 with the outer side facing outwards. The cut mark is usually located on the outer side of the tape, which allows it to be correctly positioned for the next step. If the cut mark is located on the inner side of the tape for a particular type, the apparatus 10 could be rotated accordingly in the opposite direction.

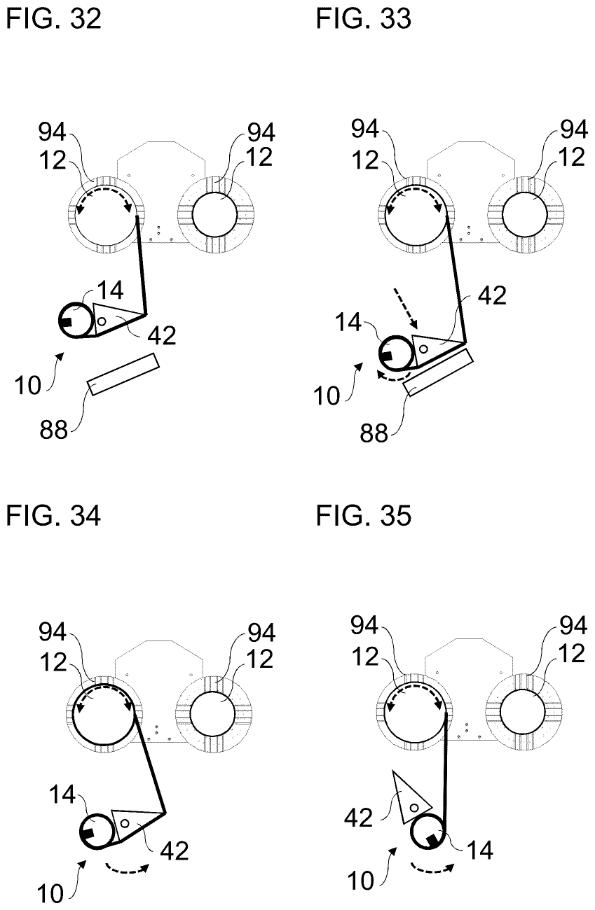

FIGS. 32 and 33 show how the adhesive tape dispenser 88 is approached by the apparatus 10 using the robot arm, and a cut-mark recognition takes place. Preferably, the tape force control can be active. The apparatus 10 can be moved from the robot arm to a cut mark sensor. The cut mark sensor is preferably arranged on the adhesive tape dispenser 88. Like the adhesive tape dispenser 88, the cut mark sensor can be either stationary in front of the robot 86 or fastened on the robot, e.g., rotating together with the first robot axis. At the cut mark sensor, the label tape can be conveyed past in a uniform manner by winding it onto the shaft 14, allowing the cut mark to be recognized. The position of the cut mark relative to shaft 14 can be detected and stored.

FIGS. 34 to 37 show how the apparatus 10 can be moved into a home position by the robot arm. Preferably, the tape force control can be active. For example, the apparatus 10 can be rotated back to its home position by approximately 270° by the robot arm.

FIGS. 38 to 41 show how an inner side of the label tape can be placed around the apparatus 10. Preferably, the tape force control can be active. The apparatus 10 can be rotated by the robot arm by approximately 270° in the opposite direction to the step from FIGS. 28 to 31. In the illustration shown, the apparatus 10 can be moved by the robot arm so that the label tape rests against the base body 42 with the inner side facing out. In the illustrated case (with the two, horizontally lying label roll receptacles 94 and the automatic bonding device 96 in-between), the adhesive tape for the left label roll receptacle 94 must be applied to the inner side. For the right-hand label roll receptacle 94, the adhesive tape must be applied to the outer side of the label tape. If the sides of the cut mark and the adhesive application were to coincide on a label tape, steps 34 to 41, for example, could be omitted.

FIGS. 42 and 43 show how the adhesive tape dispenser 88 is approached by the apparatus 10 and adhesive, e.g., in the form of a double-sided adhesive strip, is applied. Preferably, the tape force control can be active. The apparatus 10 can be moved to the adhesive tape dispenser 88 using the robot arm. With the aid of the stored position of the cut mark, the label tape can be positioned correctly on the base body 42 by the shaft 14, so that the adhesive/adhesive tape can be applied in the correct position. The tape force control can then be deactivated. A roll unit 98 of the adhesive tape dispenser 88 can come into contact with the base body 42. The adhesive can be applied to the label tape. The position of the applied adhesive strip relative to shaft 14 can be stored. Contact with the roll unit can be ended.

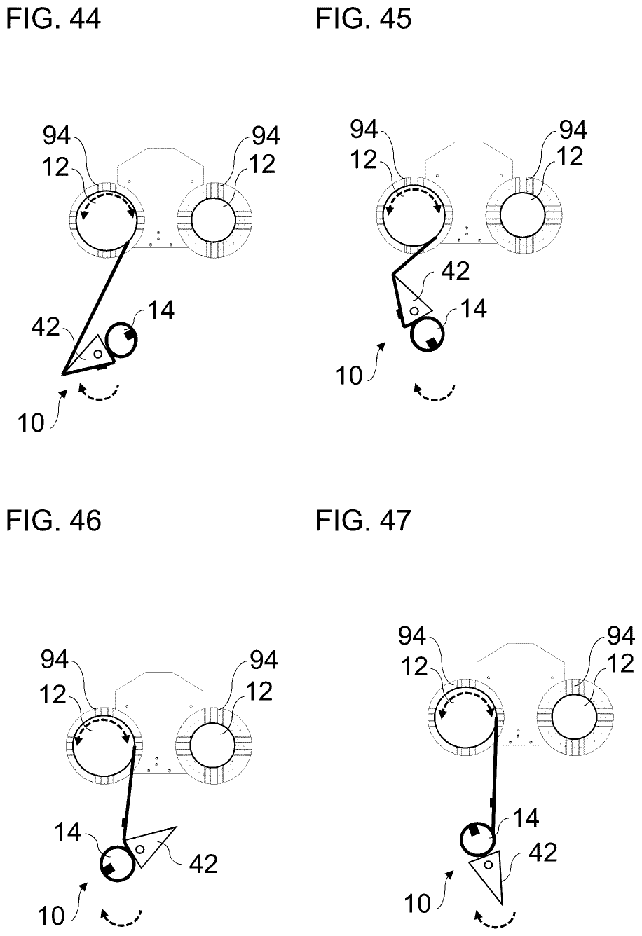

FIGS. 44 to 47 show how the apparatus 10 can be moved into a home position by the robot arm. Preferably, the tape force control can be active. For example, the apparatus 10 can be rotated back to its home position by approximately 270° by the robot arm.

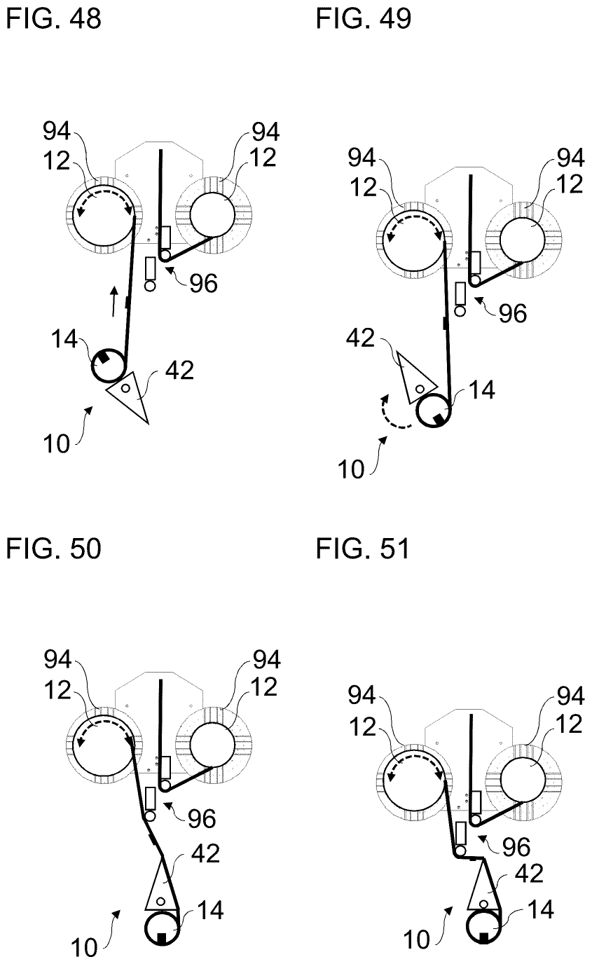

FIG. 48 shows how the adhesive strip applied to the label tape by the adhesive tape dispenser 88 can be positioned. Preferably, the tape force control can be active. The label tape can be wound a short distance onto the label roll receptacle 94, so that the adhesive strip does not come into contact with the apparatus 10 in the following step. Preferably, the adhesive strip is positioned so that it is already in the correct position on the base body 42 in the transfer position to the bonding device 96. However, the position of the adhesive strip could also be corrected in a later step.

FIG. 49 shows how the apparatus 10 can be pivoted. Preferably, the tape force control can be active. The apparatus 10 can be rotated by the robot arm by, for example, approximately 180° in order to align itself and the label tape for transfer to the bonding device 96.

FIGS. 50 to 54 show how the apparatus 10 can be moved to the bonding device 96. Preferably, the tape force control can be active. The apparatus 10 can, using the robot arm, pull the label tape over a roller of the bonding device 96—here, the left half of the bonding device. Finally, the current transfer side of the apparatus 10 can be aligned largely parallel to the inner side of the bonding device 96. The distance between the side face of the base body 42 and the bonding device 96 is preferably 1 mm to 5 mm.

FIG. 55 shows how a suction bar of the bonding device 96 extends. The tape force control can preferably be inactive. The suction bar of the bonding device 96 can be extended and come into contact with the transfer side of the base body 42 in the region of the applied adhesive strip and fix the label tape. The transfer bar 62 can be located below the adhesive strip (see, for example, FIG. 7). By moving the label roll receptacle 94, the label tape can be easily relaxed on one side (running around the roll of the bonding device 96). To support the fixing of the tape, the negative pressure at the suction bars of the bonding device 96 and at the suction device 50 of the base body 42 can be activated.

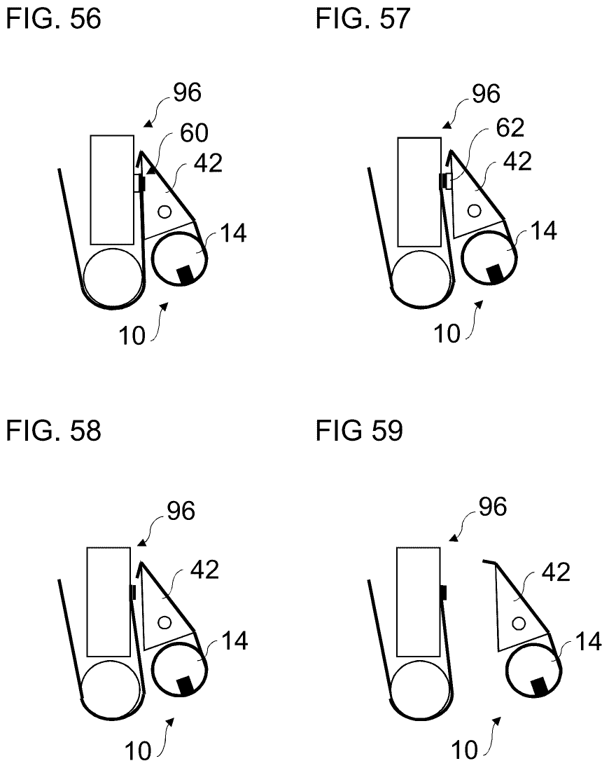

FIG. 56 shows how the cutting blade 60 can be extended and the label tape can be cut. Preferably, the tape force control can be inactive. The cutting blade 60 can be extended from the base body 42. Thus, the label tape can be cut to the correct position. A tape remnant on the apparatus 10 can be fixed by the suction device 50 (on the right side). The suction device 50 on the left side of the base body 42 can be deactivated.

FIG. 57 shows the transfer of the label tape to the bonding device 96. Preferably, the tape force control can be inactive. Preferably, the suction bar of the bonding device 96 can be retracted. The transfer bar 62 of the base body 42 can extend by spring force and fix the label tape during the movement of the suction bar of the bonding device 96.

FIG. 58 shows that the cutting blade 60 can be retracted back into the base body 42. Preferably, the tape force control can be inactive.

FIG. 59 shows how the apparatus 10 can be moved away from the bonding device 96. Preferably, the tape force control can be inactive. The apparatus 10 can be moved away from the bonding device 96 using the robot arm, and the label tape remnant on the apparatus 10 can be removed.

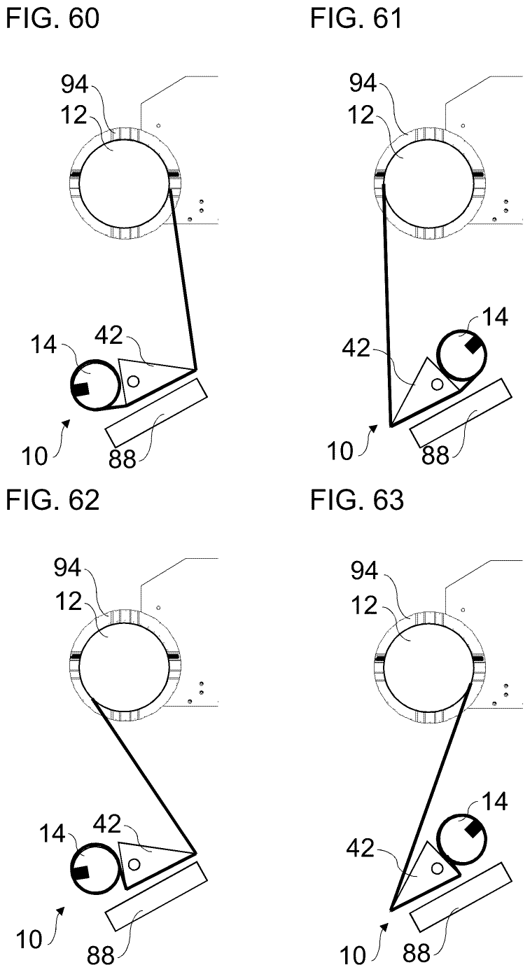

FIGS. 60 to 63 show variants of method steps depending upon the label tape or the label roll 12. Depending upon the winding direction of the label roll 12, the side of the cut mark, along with the side of the adhesive application on the label tape, the apparatus 10 can be pivoted in different ways by the robot arm in order to engage the correct side of the tape. For example, the following tape paths result.

FIG. 60 shows a variant in which the winding direction of the label roll 12 is on the right, and the cut-mark recognition or adhesive application takes place on the outer side of the tape.

FIG. 61 shows a variant in which the winding direction of the label roll 12 is on the left, and the cut-mark recognition or adhesive application takes place on the outer side of the tape.

FIG. 62 shows a variant in which the winding direction of the label roll 12 is on the left, and the cut-mark recognition or adhesive application takes place on the inner side of the tape.

FIG. 63 shows a variant in which the winding direction of the label roll 12 is on the right, and the cut-mark recognition or adhesive application takes place on the inner side of the tape.

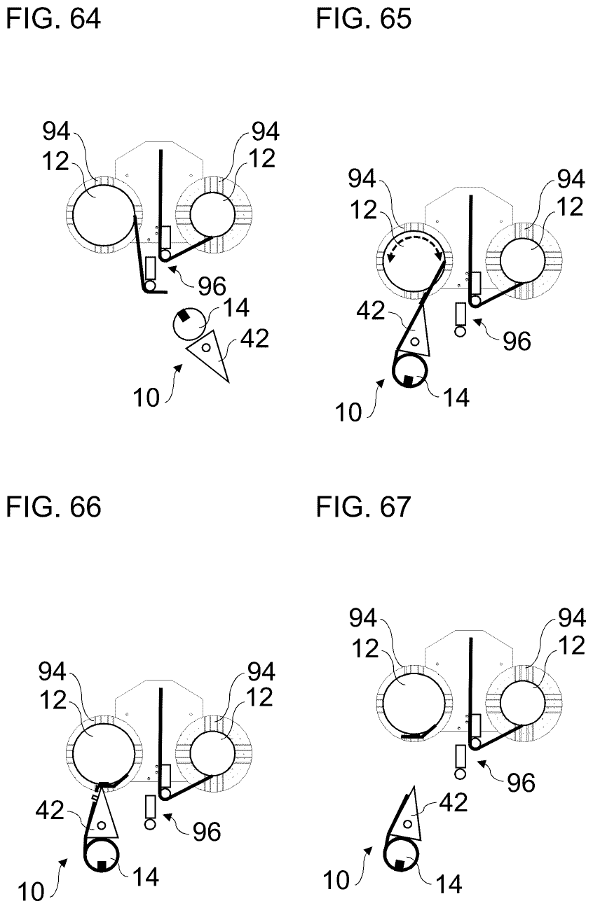

FIGS. 64 to 67 show that re-attaching the leading end of the tape of a partially used label roll 12 is likewise possible using the apparatus 10.

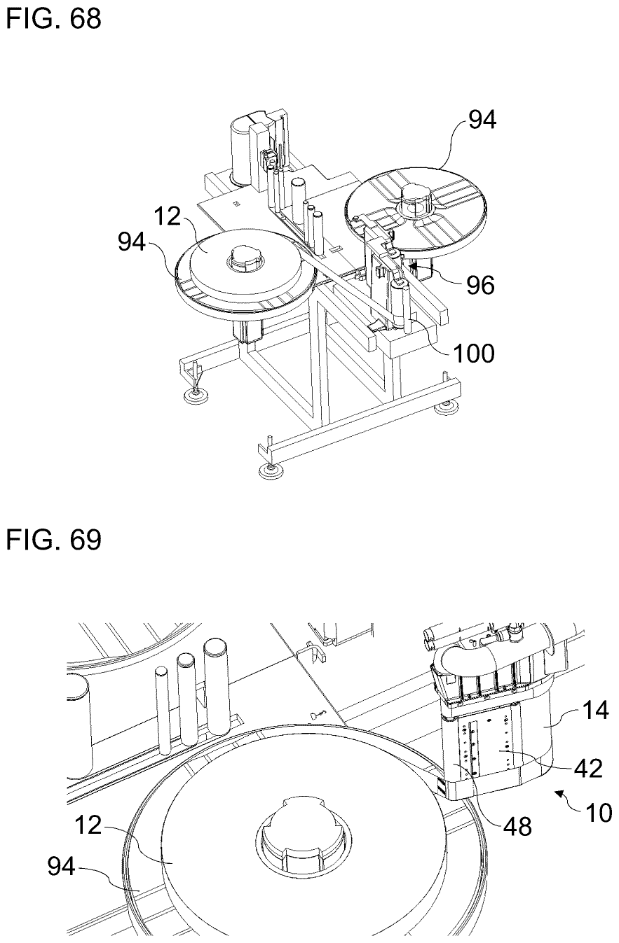

FIG. 64 shows that, after switching from a partially used label roll 12 (left) to a new label roll 12 (right), a leading end of the tape can, for example, be fixed at the bonding device 96 (see FIG. 68 by way of example) and can then be received by the shaft 14.

FIG. 65 shows, analogously to the normal procedure, that adhesive tape can be applied to the label tape with the aid of the adhesive tape dispenser 88 (not in the correct position; therefore, no cut-mark recognition is necessary); see also FIG. 69 by way of example.

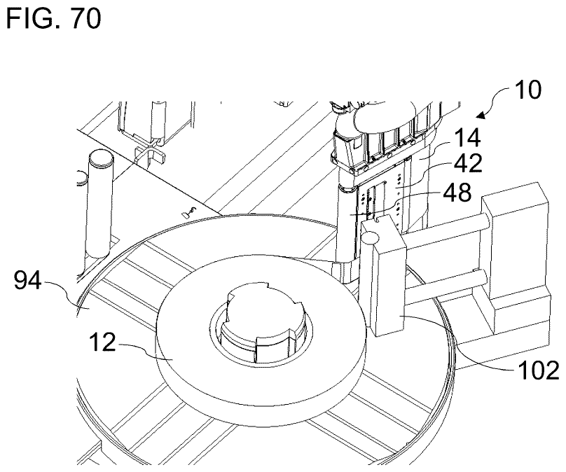

FIG. 66 shows that the adhesive tape can be pressed onto the label roll 12 (left) with the aid of the base body 42 (e.g., its tip), and the label tape can be cut with the aid of the cutting device of the apparatus 10 such that there is again a tape overhang of a few cm. For example, a pressure bar can be provided on the label roll receptacle 94 as a counterpart for the apparatus 10 in order to better cut the label tape (see also FIG. 70 by way of example).

FIG. 67 shows that the apparatus 10 can remove the tape remnant. Optionally, the robot arm can switch to a roll gripper and receive the label roll 12 (left) from the label roll receptacle 94.

FIG. 68 shows that the bonding device 96 can be assigned, for example, a movable roller 100 or another element. The end of the label tape can be fixed to the bonding device 96 using the roller/element 100.

FIG. 69 shows how the apparatus 10 brings the label tape, when re-attaching the leading end of the tape with the applied adhesive strip, close to the label roll 12 on the label roll receptacle 94 for bonding with the label roll 12.

FIG. 70 shows a variant having a movable pressure bar 102 on the label roll receptacle 94. The pressure bar 102 can serve as a counterpart for the cutting device 56 of the base body 42 of the apparatus 10.

FIGS. 71 and 72 show an exemplary receiving device 104 for receiving tape remnants.

Preferably, the receiving device 104 can be used in combination with the apparatus 10 and pick up tape remnants from the shaft 14 of the apparatus 10. However, it is also possible, for example, to use the receiving device 104 with any other handling unit that carries a tape remnant.

Preferably, the receiving device 104 is arranged in a stationary manner. For example, the receiving device 104 can be arranged in the working area of the robot 86, e.g., adjacent to the label roll receptacles 92 or as part of the labeling system 92 (see FIG. 23).

Preferably, the receiving device 104 has a suction unit 106, a clamping unit 108, and a collection container 110. Optionally, the receiving device 104 can also comprise, for example, a deflection line 112 and/or a cover 114.

Optionally, the receiving device 104 can have sound insulation (not shown here).

Further optionally, the receiving device 104 can have openings in the housing/wall so that the airflow introduced via the suction unit 106 can be directed away in a controlled manner.

Furthermore, the receiving device 104 can optionally have at least one impact element, such as an impact plate, in order to catch the labels in a controlled manner and to guide them, for example, in a desired direction (e.g., toward the box/case mentioned below or toward the collection container 110). The impact element can be arranged, for example, in the line system and/or in the collection container 110, e.g., in an inlet region of the collection container 110.

Optionally, the receiving device 104 can have an (e.g., removable or interchangeable) box/case (e.g., as part of the collection container 110). The collection container 110 can preferably have an openable access, e.g., a flap, lid, or door, for making the box/case accessible—for example, in order to empty or change the box/case.

In addition, the receiving device 104 can optionally have an (e.g., fill-level) sensor, which is arranged to monitor a label fill level in the collection container 110, e.g., in the crate/box. Depending upon a signal output from the sensor, an action can be performed via a controller depending upon the level/message, e.g., information to a user via a user interface on emptying or changing the collection container 110 or the box/crate.

The suction unit 106 is formed to draw in air through the clamping unit 108 and to convey the air that has been sucked in, if necessary via the deflection line 112, to the collection container 110. Using the air that has been sucked in, a tape remnant can likewise be sucked in using the suction unit 106.

Preferably, the suction unit 106 can generate a negative pressure in the clamping unit 108 and discharge all objects and gases sucked in through the clamping unit 108 into the collection container 110—if necessary, via the deflection line 112.

For example, the suction unit 106 can be configured as a volume flow amplifier. A volume flow amplifier can convert energy from high pressure at a low volume flow rate to low pressure at a high volume flow rate. For example, a suction air volume flow rate generated using the suction unit 106 through the clamping unit 108 can be a multiple of, e.g., three times, an inlet volume flow rate of compressed air that discharges radially into the suction unit 106.

As an alternative to the volume flow amplifier, another technique could be used for generating the extraction effect. For example, the suction unit 106 can have a side channel blower. The side channel blower can generate a vacuum. In such a configuration, it is preferred that the collection container 110 be sealed in an airtight manner. For example, the cover 114 could be arranged as a closed plate, e.g., a sheet metal plate, for sealing the collection container 110 in an airtight manner. The vacuum generated by the suction unit 106 can be introduced into the collection container 110. A vacuum can then be generated at the clamping unit 108 via the optional deflection line 112, with which the tape remnant can be sucked in. A combination of volume flow amplifier and side channel blower is also conceivable.

It is possible that the suction unit 106 can be supported by additional compressed air nozzles (not shown in FIGS. 71 and 72). The compressed air nozzles can, for example, be arranged at the inlet of the clamping unit 108. This can be particularly advantageous with wide label tapes, which tend to crumple and thus clog up in the region of the suction unit 106. Advantageously, clogging can be effectively prevented by the compressed air nozzles.

The clamping unit 108 is arranged for clamping the tape remnant that is sucked into the clamping unit 108 by the suction unit 106. Preferably, the clamping unit 108 can be arranged upstream of the suction unit 106 with respect to an airflow sucked in by the suction unit 106.

The clamping unit 108 can, for example, have two clamping elements that are movable relative to one another. The clamping elements can, for example, be configured as clamping plates. The leading end of the tape remnant that has been sucked in can be clamped between the clamping elements. The clamping elements can, for example, be plate-shaped or strip-shaped.

Preferably, one or both of the clamping elements can be at least partially profiled and/or elastically compressible. For example, one of the clamping elements or both clamping elements can have grooves or teeth that, for example when the clamping elements are pressed together, generate a kind of form fit. An elastomer can also be used on one or both of the clamping elements and can preferably increase the clamping force by increasing the frictional force.

A clamping gap formed between the clamping elements of the clamping unit 108 can exhibit any orientation. Preferably, the clamping gap can be aligned horizontally or vertically.

Preferably, the clamping unit 108 can be pneumatically actuated. For example, compressed air can be fed via a compressed air line to a pneumatic clamping actuator of the clamping unit 108 for moving one or both clamping elements. The clamping actuator can, for example, be an inflatable bellows or a pneumatic cylinder.

Alternatively, the clamping unit 108 can be driven by another technique. For example, the clamping unit 108 can have an electric drive unit for moving one or both clamping elements.

The collection container 110 serves to collect the tape remnants that have been sucked in. With respect to an airflow sucked in by the suction unit 106, the collection container 110 can be arranged downstream of the suction unit 106 and, if necessary, downstream of the deflection line 112.

Preferably, the collection container 110 can be opened for emptying. For example, the cover 114 can be released from the collection container 110 in order to open the collection container 110. Preferably, the cover 114 can be released from the collection container 110 without tools. The cover 114 can, for example, be arranged on an upper side of the collection container 110. The cover 114 can, for example, have a handle for removing it from the collection container.

Preferably, the cover 114 can be configured as a cover grid.

The deflection line 112 can connect the suction unit 106 and the collection container 110 to one another. The deflection line 112 can deflect the airflow, sucked in by the suction unit 106, toward the collection container 110, e.g., at an angle of approximately 90°. Advantageously, by deflecting the airflow using the deflection line 112, there is no danger to the operating personnel, even in the event of particles that have been sucked in. Exhaust air, labels, particles, etc., can be safely directed downwards into the collection container 110.

It is possible that at least one of the suction unit 106, the clamping unit 108, the collection container 110, the deflection line 112, and the cover 114 is formed partially or completely from a plurality of adjacent, additively manufactured material layers. The material layers can be made of polyamide, e.g., PA12. It is also possible that the entire receiving device 104 is formed as a single, additively manufactured component (e.g., a one-piece, 3-D printed part).

It is also conceivable that the inner faces of the suction unit 106, the clamping unit 108, and/or the deflection line 112 be coated, e.g., in order to prevent possible adhesion of the tape remnants. The coating could, for example, contain silicone or PTFE.

The receiving device 104 can be operated, for example, as follows.

The clamping unit 108 can be opened, and the suction unit 106 can be activated. The robot 86 (see FIG. 23) can move the apparatus 10 it carries in front of the clamping unit 108 such that an end of the tape is sucked into the suction unit 106. In order to increase process reliability, the completed sucking-in can preferably be monitored by a sensor arranged on the clamping unit 108 or on the suction unit 106.

Once the protruding end of the tape has been sucked into the clamping unit 108, the clamping unit 108 can be closed, and the suction unit 106 can be deactivated. The tape end of the tape remnant can now be securely fixed to the clamping unit 108.

Preferably, the robot 86 (see FIG. 23) can now execute a movement in which the shaft 14 (with the tape remnant wound onto it) is removed (moved away) from the clamping unit 108. At the same time, the shaft 14 can rotate at a speed such that the tape remnant can be unwound from shaft 14. Alternatively, it is possible, for example, for the drive of the shaft 14 to be switched off and, if applicable, a motor brake to be released, so that the shaft 14 can rotate freely when the tape is pulled off. This can be particularly useful in the case of a directly driven shaft 14, due to the drive without any gearbox interposed.

Preferably, the tape remnant can be taut during unwinding in order to avoid tangling. Since the tape remnant can be unwound from shaft 14 under tension, the tape remnant can be removed from shaft 14 with high process reliability. Even any adhesive tape residue that may be present on the tape does not impair its function.

Once the tape remnant has been completely unwound from the shaft 14, the suction removal can be reactivated using the suction unit 106, and the clamping can be reopened using the clamping unit 108. Preferably, the tape remnant can then be completely sucked in and, if necessary, directed via the deflection line 112 into the collection container 110.

It is also possible that the process takes place in several repeating steps. For example, the end of the tape can be sucked in by the suction unit 106 and clamped by the clamping unit 108. Afterwards, the tape remnant can be unwound from the shaft 14 by a predetermined length, e.g., by 0.5 m. Then, the suction removal can be activated using the suction unit 106, and the clamping unit 108 can be opened again. The unwound 0.5 m tape remnant can be sucked in while the robot 86 brings the shaft 14 closer to the clamping unit 108 by this length. The clamping unit 108 can then be closed again, and the next portion of tape can be unwound, e.g., 0.5 m again, etc.

In this way, the robot 86 does not have to unwind the entire tape remnant all at once. Instead, the unwinding takes place in a plurality of steps, which can increase process reliability, e.g., due to the shorter freely suspended tape length.

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the dependent claims are also disclosed independently of all features of independent claim 1 and, for example, independently of the features with respect to the presence and/or configuration of the shaft and/or the base body of independent claim 1. All ranges specified herein are to be understood as disclosed in such a way that all values falling within the relevant range are individually disclosed, e.g., also as the relevant preferred narrower outer limits of the relevant range.

### LIST OF REFERENCE SIGNS

10 apparatus
12 label roll
14 shaft
16 longitudinal gap
18 shoulder
20 drive unit
22 transmission connection
24 compensating coupling
26 suction device
28 suction nozzle
30 vacuum line
32 clamping device
34 clamping element
36 compressed air line
38 clamping actuator
40 tape sensor
42 base body
44 receptacle
46 shoulder
48 guide roller
50 suction device
52 heating device
54 reflector
56 cutting device
58 cutting actuator
60 cutting blade
62 transfer bar
64 cutting device
66 upper part
68 support flange
70 carrier body
72 carrier body
74 connection interface
76 input/output module
78 valve manifold
80 Venturi nozzle
82 vacuum line
84 sensor
86 robot
88 adhesive tape dispenser
90 bellows suction gripper
92 labeling system
94 label roll receptacle
96 bonding device
98 roll unit
100 roller
102 pressure bar
104 receiving device
106 suction unit
108 clamping unit
110 collection container
112 deflection line
114 cover
a, b, c distances
K adhesive strips
M central axis
P adhesive application position

1. An apparatus for handling a label tape, wherein the apparatus has:
a shaft for rolling up a portion of the label tape from a label roll for holding the label tape on the shaft; and
a base body that is arranged next to the shaft for applying a portion of the label tape adjacent to the rolled-up portion of the label tape.

2. The apparatus according to claim 1, wherein at least one of the following conditions is met:
the shaft is a hollow shaft;
an outer circumferential face of the shaft has a non-stick coating;
the shaft has a longitudinal gap for receiving a leading end of the portion of the label tape;
the shaft is rotatably mounted only at one end side of the shaft;
the shaft has at its free end a circumferential shoulder for preventing the label tape from slipping off the shaft;
the shaft has at least one of a total shaft length ≥200 mm and/or ≤300 mm; and
the shaft has at least one of an outer diameter ≥50 mm and/or ≤100 mm.

3. The apparatus according to claim 1, further having at least one of the following:
a suction device for drawing in the label tape for at least one of to the shaft and into the shaft; and
a clamping device for clamping the label tape for at least one of in the shaft and on the shaft.

4. The apparatus according to claim 3, wherein at least one of the following conditions is met:
the suction device is arranged in the shaft;
the suction device is connected to the shaft in a rotationally fixed manner;
the suction device has a suction nozzle for sucking in a leading end of the portion of the label tape into the suction nozzle, wherein the suction nozzle opens in at least one of an outer circumferential face of the shaft in a longitudinal gap of the shaft and substantially along an entire length of the shaft; and
the suction device has a vacuum line that is arranged in the shaft parallel to and at a distance from a central longitudinal axis of the shaft.

5. The apparatus according to claim 3, wherein at least one of the following conditions is met:
the clamping device is arranged in the shaft;
the clamping device is pneumatically actuated;
the clamping device has two clamping elements that are movable relative to one another;
the clamping device is connected to the shaft in a rotationally fixed manner;
the clamping device is arranged to clamp a leading end, sucked into the shaft, of a portion of the label tape; and
the clamping device extends substantially along an entire length of the shaft.

6. The apparatus according to claim 2, further having:
a tape sensor that is arranged to detect a label tape held by the shaft.

7. The apparatus according to claim 1, further having:
a drive unit that is connected to the shaft in a driving manner for rotating the shaft.

8. The apparatus according to claim 1, wherein the base body has at least one of the following:
at least one cutting device for cutting off the portion of the label tape resting against the base body;
at least one suction device for holding the portion of the label tape resting against the base body;
at least one reflector for print mark recognition on a transparent label tape;
at least one heating device for heating the portion of the label tape resting against the base body;
at least one deflecting element, on at least one edge region of the base body for guiding the label tape around the respective edge region; and
at least one elastically mounted, preferably spring-loaded, transfer bar for supporting a transfer of the label tape resting against the base body.

9. The apparatus according to claim 1, wherein at least one of the following conditions is met:
the base body has a receptacle into which the shaft partially immerses;
the base body has at its free end a circumferential shoulder for preventing the label tape from slipping off the base body;
the base body has a substantially triangular or substantially quadrilateral cross-section; and
the base body has a total length that substantially corresponds to the total length of the shaft.

10. The apparatus according to claim 1, wherein at least one of the following conditions is met:
the apparatus an end effector for a robot;
the apparatus has a support flange for attaching the apparatus to a robot arm of a robot, to a central axis of the shaft; and
the apparatus has a connection interface for connecting a robot drag chain having at least one supply line.

11. A robot, wherein the robot has:
an apparatus according to claim 1; and, optionally:
an adhesive tape dispenser for dispensing an adhesive tape onto a portion, resting against the contact face of the base body of the apparatus, of the label tape.

12. A labeling system for labeling containers, wherein the labeling system has:
two label roll receptacles for receiving one label roll each;
a bonding device for joining a leading end of a label tape from one of the label rolls to an end of a label tape from the other label roll; and
a robot according to claim 11, which is configured to:
feed a portion of a label tape from a label roll selectively from one of the two label roll receptacles to the bonding device.

13. The labeling system according to claim 12, wherein at least one of:
the robot which is configured to prepare the portion for the bonding device by at least one of cutting it to size and providing it with an adhesive; and
the labeling system further having
a receiving device for receiving tape remnants, wherein the receiving device has a suction unit for drawing in and sucking in a tape remnant from the shaft, a clamping unit for clamping a tape remnant that has been drawn in, and a collection container for collecting remnants that have been sucked in.

14. A method for operating an apparatus according to claim 1, wherein the method comprises:
rolling up a portion of a label tape from a label roll onto the shaft for holding the label tape to the shaft; and
applying a portion of the label tape adjacent to the rolled-up portion of the label tape to the base body moving the entire apparatus.

15. The method according to claim 14, wherein the method further comprises at least one of the following:
receiving a leading end of the portion of the label tape in a longitudinal gap of the shaft before rolling up;
drawing in a leading end of the portion of the label tape onto or into the shaft using a suction device of the apparatus;
clamping a leading end of the portion of the label tape to or in the shaft using a clamping device of the apparatus;
holding the portion, adjacent to the rolled-up portion of the label tape and resting against the base body, of the label tape against the base body by drawing in using a suction device of the apparatus;
moving the apparatus with the rolled-up portion of the label tape to a treatment device for treating the label;
heating the portion, adjacent to the rolled-up portion of the label tape and resting against the base body, of the label tape by a heating device of the apparatus;
moving the apparatus with the rolled-up portion of the label tape to a bonding device of a labeling system for bonding the label tape to one end of another label tape;
adapting a tape force acting upon the label tape using at least of a drive unit connected to the shaft and using a drive unit connected to the label roll receptacle, when moving the apparatus;
cutting the label tape using a cutting device of the apparatus; and
removing a tape remnant at the shaft, comprising:
drawing in the tape remnant from the shaft using a suction unit of a receiving device;
clamping the tape remnant that has been drawn in, using a clamping unit of the receiving device;
removing the clamped tape remnant from the shaft by at least one of moving the shaft away from the clamping unit and unwinding the tape remnant from the shaft by rotating the shaft;
sucking in a tape remnant removed from the shaft into a collection container of the receiving device, using a suction unit.

16. The apparatus according to claim 6, wherein at least one of the following conditions is met:
the tape sensor is arranged in the shaft, preferably to detect the portion projecting into the shaft through a longitudinal gap in the shaft;
the tape sensor is an optical sensor, preferably a laser sensor or an LED sensor;
the tape sensor is connected to the shaft in a rotationally fixed manner; and
the tape sensor is arranged in or on a free end region of the shaft.

17. The apparatus according to claim 7 wherein at least one of:
the driver unit is an electric drive unit;
the drive unit is connected to the shaft via a transmission connection, a planetary gearbox, an angular gearbox, a cycloidal gearbox, or a belt drive;
the drive unit is connected to the shaft via at least one of a compensating coupling, an axis misalignment compensating coupling, an angular misalignment compensating coupling and a bellows coupling; and
the drive unit is configured, when the entire apparatus is moved, to drive the shaft in a force-controlled manner, depending upon a load on at least one of the shaft and the apparatus, in order to apply a tape force to the label tape, for preventing at least one of sagging and damage to the label tape.

18. The apparatus according to claim 10, wherein at least one of the following conditions is met:
the robot is a multi axis robot or an articulated-arm robot;
a central axis of the support flange is offset to a central axis of the shaft; and
the apparatus has at least one of a pneumatic and electrical connection interface for connecting a robot drag chain having at least one supply line.

19. The apparatus of according to claim 2, wherein the longitudinal gap comprises at least one of a longitudinal suction and a longitudinal clamping gap.

20. The apparatus according to claim 9, wherein the base body receptacle is substantially cylindrical segment shaped.
